(19) United States
(12) Patent Application Publication
(10) Pub. No.: US 2019/0060838 A1
(43) Pub. Date: Feb. 28, 2019

(54) POROUS MOLDED BODY

(71) Applicant: TORAY INDUSTRIES, INC., Tokyo (JP)

(72) Inventors: Ryuichiro HIRANABE, Shiga (JP); Kentaro KOBAYASHI, Shiga (JP); Masayuki HANAKAWA, Shiga (JP); Tamotsu KITADE, Shiga (JP)

(73) Assignee: TORAY INDUSTRIES, INC., Tokyo (JP)

(21) Appl. No.: 15/763,291

(22) PCT Filed: Jun. 24, 2016
(86) PCT No.: PCT/JP2016/068817

§ 371 Date: Mar. 26, 2018

(30) Foreign Application Priority Data
Sep. 29, 2015 (JP) 2015-190903
Mar. 15, 2016 (JP) 2016-050618

(51) Int. Cl. B01D 69/02; B01D 69/08; B01D 69/14; B01D 71/34; B01D 71/02; B01D 65/02; C02F 1/44; C02F 1/28; B01J 20/06; B01J 20/20; B01J 20/28; B01J 20/26

(52) U.S. Cl. CPC B01D 69/02; C02F 2303/16; B01D 69/148; B01D 71/34; B01D 71/024; B01D 65/02; C02F 1/44; C02F 1/288; B01J 20/06; B01J 20/20; B01J 20/28016; B01J 20/28004; B01J 20/261; B01J 20/28038; B01J 20/28028; B01D 2325/06; B01D 2325/12; B01D 2321/04; C02F 1/281; C02F 1/285; B01D 69/087

(57) ABSTRACT

The purpose of the present invention is to provide a porous molded body which is capable of adsorbing and removing low-molecular-weight organic matters or ions with high removal rate. The present invention relates to a porous molded body which is provided with: a plurality of columnar structures containing a crystalline polymer and having a (long side)/(short side) aspect ratio of 2 or more; and inorganic particles.

### TECHNICAL FIELD

The present invention relates to a porous molded body having an adsorption function suitable for various water treatments such as drinking water production, industrial water production, water purification treatment, wastewater treatment and seawater desalination.

### BACKGROUND ART

A synthetic resin has a wide variety of uses, and its application field to a packing material, a magnetic recording material, a printing material, an electrically insulating material and an optical material has been expanded by taking advantage of the properties of the material, by improving the properties with the help of copolymerization, blending or additives, or further by combining it with various steps or processes. Among others, demands for a porous membrane are recently increasing, and the porous membrane is utilized in various areas, e.g., a water treatment field such as water purification treatment and wastewater treatment, a medical application such as blood purification, a food industry field, a battery separator, a charged membrane, and an electrolyte membrane for fuel cells.

Above all, in the drinking water production field and industrial water production field, i.e., the water treatment field such as usage for water purification treatment, wastewater treatment and seawater desalination, a porous membrane is used as an alternative to conventional sand filtration, coagulating sedimentation and evaporation or for enhancing the quality of treated water.

As the porous membrane for water treatment, a membrane appropriate to the size of a separation target substance contained in water to be treated is used. Usually, natural water contains many suspended components, and a microfiltration membrane or ultrafiltration membrane for removal of suspended components in water is therefore used in general.

However, utilization of an additive, which is actively used in the field of molding of synthetic resins, particularly, addition of an inorganic particle, is little done in the field of porous membranes except for utilization of a pore-forming agent at the time of membrane production. It is thought that when a porous membrane contains a high concentration of inorganic particles, this gives rise to breaking.

On the other hand, demands for a membrane capable of removing small size ions or low molecular organic compounds, as well as removing suspended components, are increasing. The ions or organic compounds are, for example, arsenic contained in ground water, phosphorus contained in wastewater, and boron contained in seawater, etc., but such ions cannot be removed by filtration/separation with a porous membrane. Among these, boron in seawater is actually removed by reverse osmosis through a semipermeable membrane, but it is not easy to decrease the boron concentration to a value equal to or less than a provisional value even by reverse osmosis. For example, when the semipermeable membrane is designed as a dense membrane, the water permeation performance is reduced, leading to a rise in the processing cost such as electric power cost, and when an alkali is used so as to increase the removal ratio, deterioration of the reverse osmosis membrane is accelerated.

Studies are being made to remove ions derived from boron, etc. by an adsorbing agent containing an inorganic particle as a main component, and Patent Documents 1 and 2 describe a porous molded body containing a fibril formed of an organic polymer resin, and an inorganic ion adsorbent, in which the fibril has a void inside thereof, at least part of the void is opened to the surface of the fibril, and the inorganic ion adsorbent is supported on the outside surface of the fibril and on the surface of the internal void.

In addition, Patent Document 3 describes a composite separation membrane containing a layer of a three-dimensional network structure formed from a thermoplastic resin, and a layer formed of a porous structure which is formed from a thermoplastic resin and contains an adsorbent. In Patent Document 3, the layer formed of a porous structure containing an adsorbent forms a spherical structure, and the adsorbent is held in a pore.

### BACKGROUND ART DOCUMENTS

### Patent Documents

Patent Document 1: JP-A-2009-297707

Patent Document 2: JP-A-2007-14826

Patent Document 3: JP-A-2010-227757

### SUMMARY OF THE INVENTION

### Problems that the Invention is to Solve

The molded body or composite separation membrane obtained by these conventional techniques tends to break and suffers from poor mechanical strength. In consideration of the problems of the above-described conventional techniques, the present inventors aim at providing a porous molded body possessing high strength, while adding an inorganic particle, by using a crystalline polymer with high chemical resistance.

### Means for Solving the Problem

The present inventors have intensively studied to create a molded body to which inorganic particles having characteristics such as adsorption function are added in high concentration yet the molded body maintains sufficient strength for practical use. As a result, it was found that it can be achieved by providing a columnar texture containing inorganic particles and crystalline polymers, and thus the present invention is accomplished. Namely, the present invention relates to following [1]-[16]:

[1] A porous molded body including: a plurality of columnar textures each containing a crystalline polymer and having an aspect ratio (long side/short side) of 2 or more, and an inorganic particle.
[2] The porous molded body according to [1], in which long sides of the columnar textures are aligned in a direction from an arbitrary one end to another end.
[3] The porous molded body according to [1] or [2], in which in the columnar texture, a molecular chain of the crystalline polymer is oriented in the longitudinal direction of the columnar texture and an orientation degree π of the molecular chain calculated, based on the following formula (3), from a half-width H (°) obtained by wide-angle X-ray diffraction measurement is 0.4 or more and less than 1.0:

Orientation degree π=(180°−H)/180° formula (3)

(in which H is a half-width of an intensity distribution obtained by scanning a crystal peak in a circumferential direction in the wide-angle X-ray diffraction determination).
[4] The porous molded body according to any one of [1] to [3], in which a thickness uniformity of the columnar texture is 0.45 or more.
[5] The porous molded body according to any one of [1] to [4], in which a short-side length of the columnar texture is from 0.5 to 3 μm.
[6] The porous molded body according to any one of [1] to [5], in which the inorganic particle is included inside of the columnar texture.
[7] The porous molded body according to any one of [1] to [6], in which the crystalline polymer is a fluorine-based resin.
[8] The porous molded body according to any one of [1] to [7], in which the inorganic particle is any of an oxide, a hydroxide and a hydrous oxide of cerium or zirconium.
[9] The porous molded body according to any one of [1] to [8], which is in a hollow-fiber membrane shape.
[10] A method for producing a porous molded body, including:

1) a step of dissolving a crystalline polymer and an inorganic particle in a poor solvent for the crystalline polymer to obtain a membrane forming solution,

2) a step of solidifying the membrane forming solution by solid-liquid thermally induced phase separation in a cooling bath, and

3) a step of stretching the solidified product at a ratio of 2.0 to 5.0 times by raising a temperature thereof to 60 to 140° C.

[11] A method for producing a porous molded body, including:

1) a step of mixing a crystalline polymer and an inorganic particle by melt-kneading,

2) a step of dissolving the mixture in a poor solvent for the crystalline polymer to obtain a membrane forming solution,

3) a step of solidifying the membrane forming solution by solid-liquid thermally induced phase separation in a cooling bath, and

4) a step of stretching the solidified product at a ratio of 1.5 to 5.0 times by raising a temperature thereof to 60 to 140° C.

[12] The method for producing a porous molded body according to [10] or [11], including a step of discharging the membrane forming solution in a pressurized state from a spinneret into the cooling bath.
[13] A method for operating a hollow-fiber membrane module,

in which a hollow-fiber membrane bundle formed of a plurality of hollow-fiber membranes is inserted into a cylindrical case having one or more lateral nozzles at least on a side surface and an end nozzle on both end faces, and at both end parts of the hollow-fiber membrane bundle, end face of the hollow-fiber membrane is fixed to the cylindrical case with an adhesive with the end face being open, to form an end bonded part, and

the hollow-fiber membrane has an adsorption function of adsorbing a specific component in water to be treated,

the method includes a filtration cycle 1 including a filtration step 1 in which water to be treated is treated at least by the hollow-fiber membrane and resulting membrane filtrate is taken out through one end nozzle, a filtration cycle 2 including a filtration step 2 in which at least membrane filtrate is taken out through another end nozzle, and a regeneration step of restoring the adsorption function, and

the filtration cycle 1 and the filtration cycle 2 are performed at least one or more times between the regeneration steps.

[14] The method for operating a hollow-fiber membrane module according to [13], in which the amount of membrane filtrate obtained from the filtration cycle 1 and the amount of membrane filtrate obtained from the filtration cycle 2 between the regeneration steps are the same.
[15] The method for operating a hollow-fiber membrane module according to [13] or [14], in which the filtration cycle 1 and the filtration cycle 2 are switched alternately every time.
[16] The method for operating a hollow-fiber membrane module according to any one of [13] to [15], in which the filtration cycle 1 includes a backwashing step 1 of supplying the membrane filtrate to the hollow-fiber membrane through a lower end nozzle in the filtration step 1 to perform backwashing after the filtration step 1 and the filtration cycle 2 includes a backwashing step 2 of supplying the membrane filtrate to the hollow-fiber membrane through a lower end nozzle to perform backwashing after the filtration step 2.

### Advantage of the Invention

According to the present invention, a porous molded body having added thereto a high concentration of inorganic particles, for example, a porous molded body having added thereto an inorganic particle to which specific ions or low molecular organic compounds are adsorbed, particularly, a porous molded body capable of simultaneously performing removal of suspended components by filtration/separation and removal of specific ions or low molecular organic compounds by adsorption, is provided.

### BRIEF DESCRIPTION OF DRAWINGS

FIG. 1 is a schematic diagram illustrating a porous molded body containing a three-dimensional network structure and an inorganic particle.

FIG. 2 is a schematic diagram illustrating a porous molded body containing a spherical structure and an inorganic particle.

FIG. 3 is a schematic diagram illustrating a porous molded body containing an inorganic particle positioned outside a columnar texture.

FIG. 4 is a schematic diagram illustrating a porous molded body containing an inorganic particle included inside a columnar texture.

FIG. 5 is an enlarged image of the porous molded body containing an inorganic particle included inside a highly oriented columnar texture in Example 10.

FIG. 6 is an enlarged image of the porous molded body containing a coarse inorganic particle outside of a spherical texture in Comparative Example 1.

FIG. 7 is an enlarged image of the porous molded body containing a fine inorganic particle outside of a spherical texture in Comparative Example 5.

FIG. 8 is an enlarged image of the master pellet of a crystalline polymer and an inorganic particle in Example 10.

FIG. 9 is an enlarged image of the highly oriented columnar texture surface formed by stretching at a ratio of 2.3 times in Example 11.

FIG. 10 is an enlarged image of the highly oriented columnar texture surface formed by stretching at a ratio of 1.5 in Example 10.

FIG. 11 is an enlarged image of a spherical texture surface formed by non-stretching.

FIG. 12 is a schematic configuration diagram of a hollow-fiber membrane module according to the present invention.

FIG. 13 is a flow diagram of a membrane filtration apparatus according to the present invention.

### MODE FOR CARRYING OUT THE INVENTION

### 1. Porous Molded Body

The porous molded body according to the present invention includes a plurality of columnar textures each containing a crystalline polymer and having an aspect ratio (long side/short side) of 2 or more, and an inorganic particle.

### 1-1. Columnar Texture

The porous molded body of the present invention contains a columnar texture. The columnar texture is a solid material having a shape long in one direction. The porous molded body has a plurality of columnar textures.

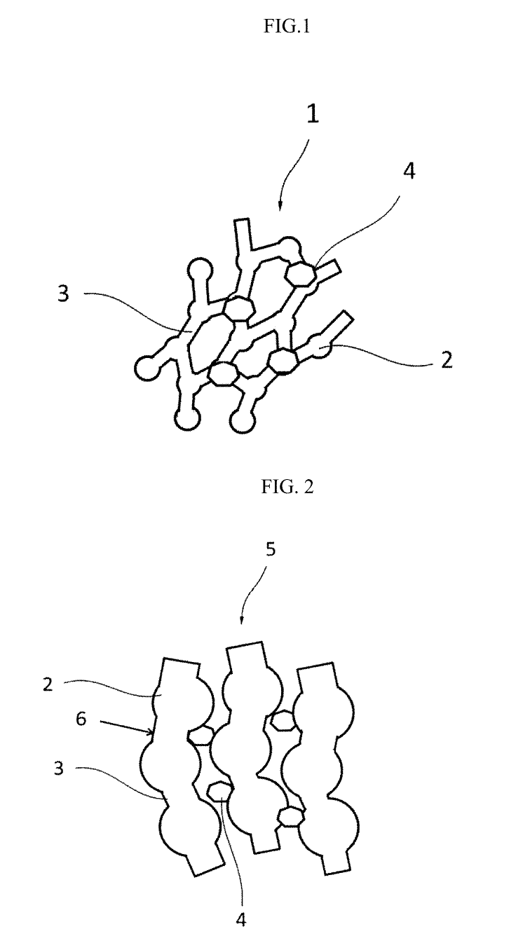

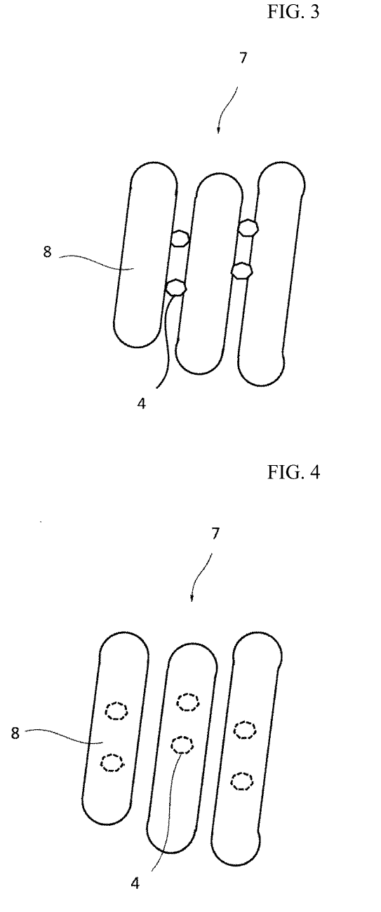

FIG. 1 shows a schematic diagram of a three-dimensional network structure, FIG. 2 shows a schematic diagram of a spherical structure, and each of FIGS. 3 and 4 shows a schematic diagram of a columnar structure.

The three-dimensional network structure 1 illustrated in FIG. 1 has a spherical portion 2 and a fibril 3. In the three-dimensional network structure 1, the spherical portion 2 is small, and fibrils 3 are intertwined with each other to form a three-dimensional network. In this case, the inorganic particle 4 is held by being attached to and supported on the three-dimensional network structure, but the three-dimensional network structure has low pure-water permeation performance and it is easily broken at the interface between the inorganic particle 4 and the fibril 3, and thus its strength is low. In addition, due to large amount of a polymer attached to the inorganic particle, the exposed surface is small and thus in the case of adding an inorganic particle having an adsorption function, the adsorption rate is low.

As illustrated in FIG. 2, the spherical structure 5 also has a spherical portion 2 and a fibril 3. However, in the spherical structure 5, due to large growth of the spherical part 2, the fibril 3 is short and thick, and the fibril 3 is therefore recognized as a narrowed part 6 between spherical parts 2. Hereinafter, the grown spherical part 2 is referred to as “spherical texture”. A void is formed by the narrowed portions 6, and a molded body having the spherical structure 5 has higher pure-water permeation performance than a molded body having the three-dimensional network structure 1. However, on the other hand, in the spherical structure 5, when a stress is generated in the molded body, the stress is concentrated between the inorganic particle 4 and the narrowed portion 6 as a result, deformation or breaking of the molded body is likely to occur.

The columnar structure 7 illustrated in FIG. 3 is an aggregate of columnar textures 8. In the columnar texture 8, the fibril is grown to the same level as the spherical part and therefore, the narrowed portion 6 is undistinguishable, compared to the spherical structure 5. Since the columnar structure 7 has a columnar texture 8 with relatively high thickness uniformity, a stress can be dispersed and in turn, high strength of the porous molded body is obtained. FIG. 4 also illustrates a columnar structure, but while the inorganic particle 4 is positioned outside the columnar texture 8 in FIG. 3, the inorganic particle 4 is included inside the columnar texture 8 in FIG. 4. When the inorganic particle is included inside, higher strength is obtained. In FIGS. 1 to 4, the inorganic particle is indicated by numerical reference “4”.

Specifically, in the columnar texture, the aspect ratio (i.e., ratio of long side/short side) is 2 or more. Thanks to the presence of a columnar texture having an aspect ratio of 2 or more, even when an inorganic particle is contained, high strength can be obtained.

The aspect ratio is preferably 3.5 or more, more preferably 8 or more. In addition, the aspect ratio is preferably 20 or less, more preferably less than 15, still more preferably less than 12. Long sides of the columnar textures are preferably aligned in the same direction from arbitrary one end to arbitrary another end, more preferably aligned in parallel in the longitudinal direction of the porous molded body. When long sides are aligned in the same direction, the tensile strength in the long-side direction can be increased, and when long sides of the columnar textures are aligned in parallel in the longitudinal direction of the porous molded body, this configuration can be usefully utilized for tension particularly in an anisotropic shape such as fiber and hollow-fiber membrane.

Here, the longitudinal direction of the porous molded body is an axial direction in which the membrane-forming solution runs after being discharged from a spinneret at the time of molding of the porous molded body. When the porous molded body is a hollow-fiber membrane or a fiber, the longitudinal direction is a direction perpendicular to the hollow surface and in the case of a flat membrane or a sheet, it is a long-length direction at the time of being wound on a core. The transverse direction of the porous molded body is a direction perpendicular to the longitudinal direction, i.e., an in-plane direction of the hollow surface in the case of a hollow fiber or a fiber and is a short-length direction at the time of being wound on a core in the case of a flat membrane or a sheet. In the columnar texture, the “long side” indicates the length of a longest portion of the columnar texture, and the “short side” indicates the length when a line is drawn perpendicularly from the central part of the longest portion of the columnar texture. These lengths are determined by measuring the length of the columnar texture at arbitrary 20 points or more and calculating the average value thereof.

The porous molded body of the present invention is formed by aggregation of a plurality of columnar textures each having the above-described aspect ratio, and the proportion of the columnar texture in the porous molded body is preferably 60% or more, more preferably 80% or more, still more preferably 90% or more. The structure other than columnar includes, for example, a spherical texture having an aspect ratio of less than 2. When the short side and long side of the spherical texture are in the range of 0.5 μm or more and less than 3 μm, reduction in the strength is prevented, and good pure-water permeation performance is maintained. However, if the proportion of such a spherical texture in the porous molded body is increased, the possibility of an inorganic particle being present in the vicinity of the narrowed portion between spherical textures increases, and a stress from the inorganic particle is disadvantageously applied to the narrowed part to readily cause fiber breakage. For this reason, the proportion of the columnar texture is preferably as large as possible.

Here, the occupancy (%) of the columnar texture is determined by taking a photograph of a cross-section in the longitudinal direction of the porous molded body by means of SEM, etc. at a magnification enabling clear identification of a columnar texture and a spherical texture, preferably at a magnification of 1,000 to 5,000 times, then dividing the occupied area the columnar texture by the area of the entire photograph of the molded body, and multiplying the obtained value by 100. In order to increase the accuracy, it is preferable to determine the occupancy for arbitrary 20 or more cross-sections and calculate an average value thereof. Incidentally, the area of the entire photograph and the area occupied by a texture can be determined preferably by employing a method of replacing the area by the weight corresponding to each texture photographed. That is, after the photograph taken is printed on paper, the weight of paper corresponding to the entire photograph and the weight of paper corresponding to a texture portion cut out therefrom may be measured. In addition, before taking a photograph by SEM, etc., the above-described resin embedding/dyeing treatment and FIB cutting are preferably applied, because the observation accuracy increases.

In the case of using the porous molded body of the present invention in a filter state, the pure-water permeation performance at 50 kPa and 25° C. is preferably 0.5 m³/m²/hr or more, more preferably 1.0 m³/m²/hr or more, still more preferably 1.5 m³/m²/hr or more. When the pure-water permeation performance is 0.5 m³/m²/hr or more, the throughput is increased, and cost superiority can be achieved. On the other hand, in the case of molding the porous molded body in a hollow-fiber membrane shape or a fiber shape, the breaking strength is preferably 3 MPa or more, more preferably 7 MPa or more, still more preferably 10 MPa or more. Since a trade-off relationship is established between pure-water permeation performances and breaking strength due to, for example, the number of textures per membrane volume, a more preferable configuration is that the pure-water permeation performance at 50 kPa and 25° C. is from 1.5 m³/m²/hr or more and the breaking strength is 3 MPa or more. In particular, from the viewpoint of forming a high-performance hollow-fiber membrane satisfying both high pure-water permeation performance and high strength, it is preferred that the pure-water permeation performance at 50 kPa and 25° C. is from 0.5 to 5.0 m³/m²/hr and the breaking strength is from 7 to 60 MPa, and it is more preferred that the pure-water permeation performance at 50 kPa and 25° C. is from 1.0 to 5.0 m³/m²/hr and the breaking strength is from 10 to 30 MPa.

The columnar texture constituting the porous molded body of the present invention is a solid material containing a crystalline polymer. The columnar texture preferably contains a crystalline polymer as a main component, and the proportion of the crystalline polymer in the columnar structure is preferably 80 wt % or more, more preferably 90 wt % or more, still more preferably 95 wt % or more. When the proportion of the crystalline polymer is 80 wt % or more, the membrane strength increases. The crystalline polymer includes polyethylene, polypropylene, polyvinylidene, polyester, and a fluororesin-based polymer. The fluororesin-based polymer is preferably a resin containing a vinylidene fluoride homopolymer and/or a vinylidene fluoride copolymer, and the resin may contain a plurality of kinds of vinylidene fluoride copolymers.

The vinylidene fluoride copolymer is a polymer having a vinylidene fluoride residue structure and is typically a copolymer of a vinylidene fluoride monomer with another fluorine-based monomer, etc. Such a copolymer includes, for example, a copolymer of vinylidene fluoride with one or more kinds of monomers selected from vinyl fluoride, tetrafluoroethylene, hexafluoropropylene and chlorotrifluoroethylene.

In addition, a monomer other than the above-described fluorine-based monomer, for example, ethylene, may be copolymerized to an extent not impairing the effects of the present invention. The weight average molecular weight of the fluororesin-based polymer may be appropriately selected according to the pure-water permeation performance and strength required for the polymer separation membrane, but as the weight average molecular weight increases, the pure-water permeability decreases, and as the weight average molecular weight decreases, the strength decreases. For this reason, the weight average molecular weight is preferably from 50,000 to 1,000,000. In the case of a water treatment application where the polymer separation membrane is subject to chemical cleaning, the weight average molecular weight is preferably from 100,000 to 700,000, more preferably from 150,000 to 600,000.

The porous molded body of the present invention includes a plurality of columnar textures and an inorganic particle, and the length of the short side of the columnar texture is preferably from 0.1 to 5 μm, more preferably 0.5 μm or more and less than 3 μm, still more preferably 0.7 μm or more and less than 2.5 μm. When the length of the short side of the columnar texture is 0.1 μm or more, the strength increases. In addition, when the length of the short side of the columnar texture is 5 μm or less, the void between columnar textures becomes large and in turn, good pure-water permeation performance is obtained.

The thickness uniformity (the later-described average value D) of the columnar texture in the porous molded body of the present invention is preferably 0.45 or more, more preferably 0.50 or more, still more preferably 0.65 or more. Although the thickness uniformity is 1.0 at most, the columnar texture may have a thickness uniformity of less than 1.0. Since the columnar texture has such thickness uniformity with little formation of a narrowed portion in the columnar texture, the breaking strength is increased. The smaller the variation among respective short sides of the columnar texture is, the less narrowed portion is formed in the columnar texture, and the thickness uniformity becomes higher. In the case of a spherical texture or a columnar texture with non-uniform thickness, a stress from an inorganic particle is applied to a narrowed part and causes breaking, but in the case of a columnar texture with uniform thickness, a stress can be dispersed by the columnar texture and therefore, the strength increases, which is useful. In addition, a porous molded body having a columnar texture with high thickness uniformity is advantageous also in that it can be stretched at a high ratio and be highly oriented. A highly oriented columnar texture obtained by stretching a columnar texture with high thickness uniformity also has high thickness uniformity.

The thickness uniformity of the columnar texture is determined by comparing a first cross-section and a second cross-section each running in parallel to the long-side direction of the columnar texture. In the case where the long-side direction of the columnar texture coincides with the longitudinal direction of the porous molded body, measurement may be performed relative to the longitudinal direction of the porous molded body. This is specifically described below.

At the beginning, a first cross-section and a second cross-section running in parallel to each other are selected. The distance between the first cross-section and the second cross-section is set to be 5 μm. First, in each cross-section, a portion composed of a crystalline polymer and a void portion are distinguished, and the area of the crystalline polymer portion and the area of the void portion are measured. Next, the area of a portion where when the first cross-section is projected onto the second cross-section, the portion composed of a crystalline polymer in the first cross-section and the portion composed of a crystalline polymer in the second cross-section are overlapped, namely, the overlap area, is determined. With respect to arbitrary 20 pairs of first cross-section and second cross-section, thickness uniformities A and B are determined based on the following formulae (1) and (2), respectively:

Thickness uniformity A=(overlap area)/(area of resin portion of second cross-section) formula (1)

Thickness uniformity B=(overlap area)/(area of resin portion of first cross-section) formula (2)

That is, 20 pairs of thickness uniformities A and B are obtained. A larger value means that the thickness of the columnar texture is more uniform. With respect to each pair, an average value C of thickness uniformities A and B is then calculated. That is, 20 average values C are obtained. With respect to these average values C, an average value D is further calculated. The average value D is the thickness uniformity of the columnar texture in the porous molded body.

In measuring the thickness uniformity of the columnar texture, in order to clearly distinguish the crystalline polymer portion and the void portion, it is preferable to previously perform resin-embedding of the porous molded body in an epoxy resin, etc. and dyeing treatment of the epoxy resin, etc. with osmium, etc. By such resin embedding/dyeing treatments, the void portion is filled with an epoxy resin, etc., and at the time of cross-sectional processing with a focused ion beam described later, the portion composed of a crystalline polymer and the void portion (i.e., the epoxy resin portion) can be clearly distinguished, leading to high observation accuracy.

Furthermore, in order to obtain a first cross-section and a second cross-section each running in parallel to the transverse direction of the above-described porous molded body, a scanning electron microscope (SEM) equipped with a focused ion beam (FIB) is preferably used. A face parallel to the transverse direction of the porous molded body is cut out using FIB, and FIB cutting work and SEM observation are performed. Subsequently, the same operation is repeatedly conducted 200 times at 50 nm intervals toward the long side of the columnar texture. By such continuous cross-sectional observation, information at a depth of 10 μm can be obtained. Arbitrary first and second cross-sections making the faces running in parallel to each other and being spaced 5 μm apart are selected therefrom, and the thickness uniformities can be determined using formulae (1) and (2). The observation magnification may be sufficient if it is a magnification enabling clear identification of a columnar texture and a spherical texture, and, for example, a magnification of 1,000 to 5,000 times may be used.

### 1-2. Orientation of Molecular Chain

In the porous molded body of the present invention, the molecular chain of the crystalline polymer is preferably oriented in the long-side direction of the columnar texture. At this time, the long-side direction of the columnar texture preferably coincides with the longitudinal direction of the porous molded body. The method for achieving high orientation includes stretching at a high ratio, but it has been difficult to stretch a molded body to which an inorganic particle is added at a high stretch ratio. In the present invention, it has been found that when the columnar structure is the above-described columnar structure having high thickness uniformity, stretching at a high ratio is possible. The orientation degree π of the molecular chain is preferably 0.4 or more and less than 1.0, more preferably 0.45 or more and less than 0.95, still more preferably 0.6 or more and less than 0.8. When the orientation degree in the long-side direction of the columnar structure is 0.4 or more, high modulus is achieved, and when the orientation degree is less than 1.0, the flexibility increases. Accordingly, within the range above, breaking of the columnar texture can be prevented.

The orientation degree π is calculated from a half-width H (°) obtained by wide-angle X-ray diffraction determination, based on the following formula (3):

Orientation degree π=(180°−H)/180° formula (3)

(in which H is a half-width of an intensity distribution obtained by scanning a crystal peak in a circumferential direction in the wide-angle X-ray diffraction determination).

The orientation of the molecular chain in the long-side direction of the columnar texture and the method for measuring the orientation degree π are specifically described below.

In order to calculate the orientation degree π, the columnar texture is fixed to a sample stage by arranging its long-side direction to run vertically and irradiated with an X-ray beam perpendicularly to the long-side direction of the columnar texture.

In the case where the molecular chain is unoriented, a ring-like diffraction peak is observed over the entire azimuth angle of 360°. On the other hand, in the case where the molecular chain is oriented in the long-side direction of the columnar texture, when irradiated with X-ray perpendicularly to the long-side direction, a diffraction peak is observed on an azimuth angle in the short-side direction (on the equatorial line) around 2θ=20°. The diffraction peak around 2θ=20° indicates a distance between polymer molecular chains.

The value of 2θ differs depending on the structure or blending of a polymer and may range from 15 to 30°. For example, when the crystalline polymer is a polyvinylidene fluoride homopolymer and has α crystal or β crystal, a diffraction peak derived from a (110) plane of α crystal or β crystal, i.e., a plane parallel to the molecular chain, is observed around 2θ=20.4°.

The intensity distribution in the azimuth angle direction is obtained by fixing the value of 2θ and furthermore, measuring the intensity in the range from 0° to 360° in the azimuth angle direction (circumferential direction), and the obtained result is the intensity distribution determined by scanning a crystal peak in the circumferential direction. Here, in the case where the ratio between the intensity at an azimuth angle of 180° and the intensity at an azimuth angle of 90° is 0.83 or less or is 1.20 or more, it is regarded that a peak is present, and using the intensity distribution in this azimuth angle direction, the width at a position of half the peak height (half-width H) is determined.

The orientation degree π is calculated by substituting the half-width H into formula (3).

In the porous molded body of the present invention, the orientation degree π in the long-side direction of the columnar texture is preferably 0.4 or more and less than 1.0, more preferably 0.5 or more and less than 1.0, still more preferably 0.6 or more and less than 1.0. When the orientation degree π is 0.4 or more, fiber breakage is less likely to occur. This is considered achieved because a stress locally generated from an inorganic particle is absorbed by the columnar texture.

In the intensity distribution obtained by scanning a crystal peak in the circumferential direction, when the ratio between the intensity at an azimuth angle of 180° and the intensity at an azimuth angle of 90° is more than 0.83 and less than 1.20, it is regarded that a peak is absent. That is, in this case, the crystalline polymer is determined to be unoriented.

In the case where the porous molded body contains α crystal or β crystal of polyvinylidene fluoride, the half-width H is preferably a half-width obtained using an intensity distribution determined by circumferentially scanning the crystal peak (2θ=20.4°) derived from a (110) plane of the α crystal or β crystal above in wide-angle X-ray diffraction determination.

### 1-3. Inorganic Particle

The porous molded body of the present invention includes a columnar texture and thereby has high strength despite containing an inorganic particle. The inorganic particle includes a metal oxide such as wet or dry silica, colloidal silica, alumina, zirconia, aluminum silicate, zinc oxide and copper oxide, a metal hydroxide, an inorganic metal particle, e.g., gold, silver, copper, iron, platinum, etc., and a particle of calcium carbonate, calcium phosphate, hydroxyapatite, barium sulfate, carbon black, activated carbon, etc.

Addition of such an inorganic particle at a high concentration enables to utilize the properties possessed by an inorganic particle, and the properties thereof are, for example, an adsorption function. The inorganic particle having an adsorption function can be arbitrarily selected from activated carbon, various catalysts, metal elements, derivatives thereof, etc. according to the target to be adsorbed.

Handling of a fine particulate inorganic particle is difficult, but the present invention is applicable also to such a fine particulate inorganic particle.

The secondary particle diameter or the average of primary particle diameter and secondary particle diameter of the fine particulate inorganic particle is preferably from 0.05 μm to 80 μm, more preferably 0.1 μm or more and less than 10 μm, still more preferably 0.5 μm or more and less than 2 μm.

For example, in the case where the target to be adsorbed is boron and/or phosphorus, a metal oxide and a hydrate thereof are used as the fine particulate inorganic particle, and in view of adsorption capacity, a metal oxide, a metal hydroxide, and a hydrous metal oxide are preferred. The metal oxide, metal hydroxide and metal hydrous oxide include a rare earth oxide, a rare earth element hydroxide, and a hydrous rare earth element oxide. The rare earth element constituting those oxides includes Scandium Sc of atomic number No. 21 in the periodic table of elements, yttrium Y of No. 39, and lanthanoid elements of Nos. 57 to 71, i.e., lanthanum La, cerium Ce, praseodymium Pr, neodymium Nd, promethium Pm, samarium Sm, europium Eu, gadolinium Gd, terbium Tb, dysprosium Dy, holmium Ho, erbium Er, thulium Tm, ytterbium Yb and lutetium Lu, and among these, in view of boron removal performance, the preferable element is cerium, with tetravalent cerium being preferred. A mixture of these rare earth element oxide and/or hydroxide and/or hydrous oxide is also useful.

As the percentage content of the inorganic particle in the porous molded body (wt % of the proportion of the inorganic particle in the porous molded body) is higher, the adsorption function increases. Accordingly, the percentage content is preferably 10 wt % or more, more preferably 20 wt % or more, still more preferably 30 wt % or more. On the other hand, if the percentage content is too high, the strength of the porous molded body is reduced, leading to deformation or breaking. Accordingly, the upper limit thereof is preferably 50 wt % or less, more preferably less than 40 wt %.

The method for measuring the percentage content of the inorganic particle includes:

(1) a method of dissolving the porous molded body in a good solvent for the crystalline polymer and filtering the solution, and

(2) a method of taking out the inorganic particle by combining the method above with a method of heating at 800° C. or more by an electric furnace, and calculating the weight thereof by comparison with the weight of the original porous molded body.

### 1-4. Columnar Texture and Inorganic Particle

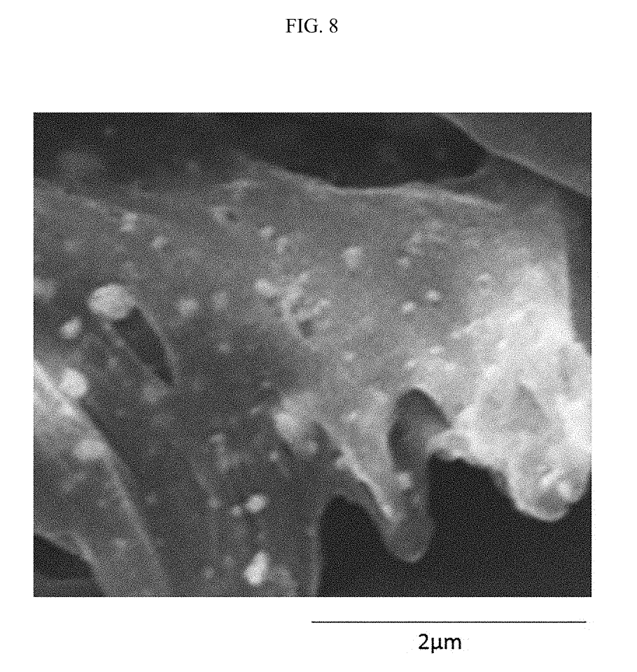

As described above, the porous molded body of the present invention contains a columnar texture and an inorganic particle. The inorganic particle may be included inside of the columnar texture or exposed to the outside but is preferably included inside, because the strength is enhanced. In the known membrane-forming method, the inorganic particle is expelled outside the texture in the process of producing a spherical texture or a columnar texture and is not included inside, but, as a result of intensive studies, the inorganic particle could be successfully included inside, and the method therefor is described later. The rate at which the inorganic particle included inside may be arbitrarily determined from the required properties, but the more inorganic particle is included inside, the higher the strength is. Accordingly, the rate is preferably 20% or more, more preferably 50% or more, still more preferably 90% or more. As to the method for causing the inorganic particle to be included inside, this can be achieved by producing a master pellet of a crystalline polymer and an inorganic particle as illustrated in FIG. 8 and then performing solid-liquid thermally induced phase separation. Details are described later.

In the conventional molded body, an inorganic particle is present in a void between thin fibrils, but out of embodiments of the present invention, in the case of an embodiment where an inorganic particle is present between relatively thick columnar textures, even though the concentration of the inorganic particle in the molded body is the same, the adsorption rate increases, and since the inorganic particle is held between high-strength columnar textures, the strength and pure-water permeation performance of the porous molded body are also increased.

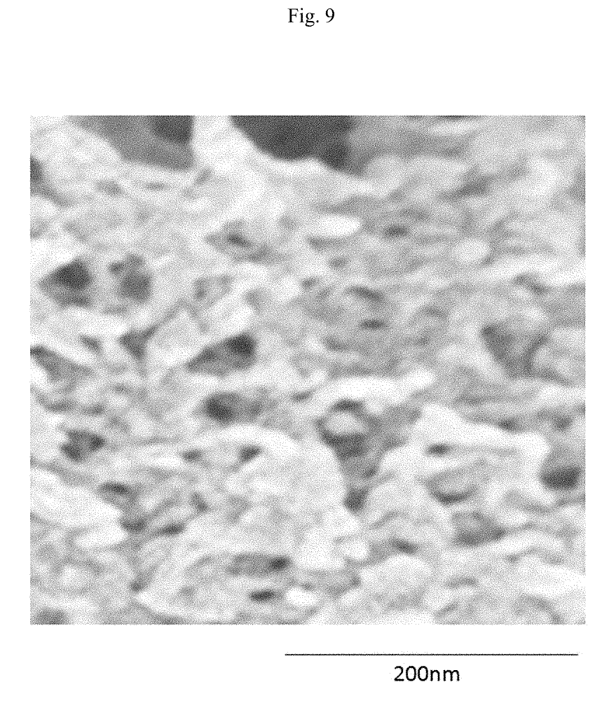

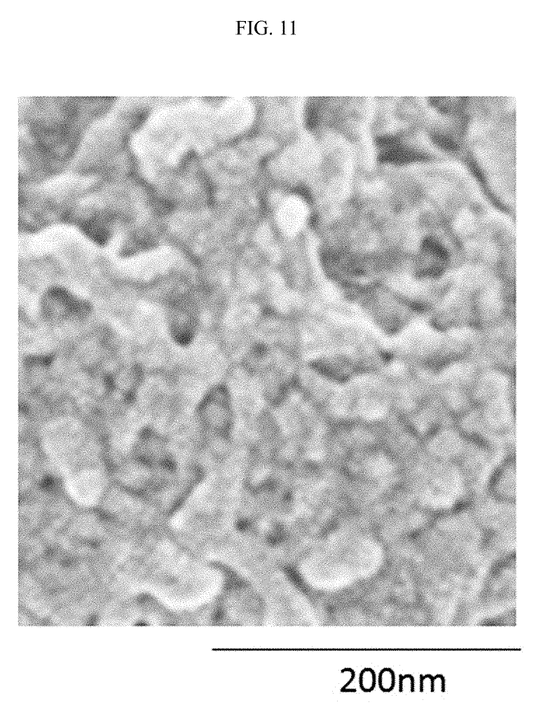

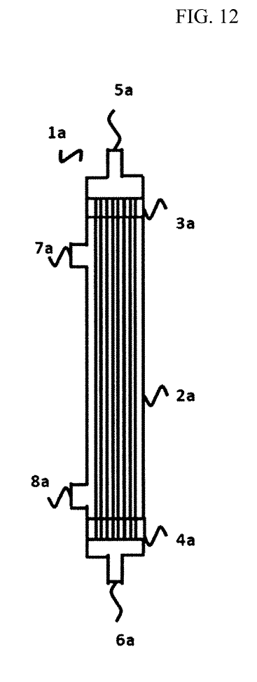

On the other hand, when the inorganic particle is included inside the columnar texture, higher strength is obtained and at the same time, in the case where the columnar texture itself is a porous body, the inorganic particle included inside the columnar texture can also take advantage of the properties thereof. When the columnar texture is in a form of porous body, the diameter of the pore thereof is preferably 0.0001 μm or more, more preferably 0.001 μm or more, still more preferably 0.005 μm or more. When the diameter is not less than the range above, a fluid readily penetrates the columnar texture and useful properties of the inorganic particle, such as adsorption, can be utilized. On the other hand, the diameter of the pore is preferably 0.1 μm or less, more preferably less than 0.05 μm, still more preferably less than 0.02 μm, and in this case, the strength of the molded body can be maintained. Each of FIGS. 9 to 11 shows an enlarged image of a columnar texture or a spherical texture. The diameter of the pore possessed by columnar and spherical textures could be successfully controlled, and the method therefor is described later.

### 1-5. Porosity

In the porous molded body of the present invention, in order to satisfy both high pure-water permeation performance and high strength, the porosity is preferably from 35 to 80%, more preferably 45% or more and less than 70%, still more preferably 50% or more and less than 65%. If the porosity is less than 35%, the pure-water permeation performance is reduced, whereas if it exceeds 80%, the strength significantly decreases and at the same time, the target can hardly contact with the inorganic particle, failing in having a sufficient adsorption function. The porosity of the porous molded body is determined according to the following formula (4) by using the area of resin portion and the area of void portion in the above-described cross-section. In order to increase the accuracy, it is preferable to determine the porosity for arbitrary 20 or more, preferably 30 or more, cross-sections and use an average value thereof.

Porosity (%)={100×(area of void portion)}/{(area of resin portion)+(area of void portion)} formula (4)

The porous molded body described above has sufficient pure-water permeation performance, strength and elongation for various water treatments such as drinking water production, industrial water production, water purification treatment, wastewater treatment and seawater desalination.

### 2. Shape

The porous molded body of the present invention may have any shape, and examples of the shape include a membrane shape such as hollow-fiber membrane or flat membrane, and a fiber shape. The fibrous porous molded body may be formed into a knitted fabric or may be cut into fine pieces after forming in a fiber shape and processed into a column.

In the following, the preferable shape is described by taking a hollow-fiber membrane as an example. The shape of the hollow-fiber membrane may be determined according to the pure-water permeation performance and adsorption function required as a membrane module without impairing the breaking strength of the membrane by taking into account the pressure loss in the length direction inside of the hollow-fiber membrane.

### 2-1. Outside Diameter

The hollow-fiber membrane of the present invention preferably has an outside diameter of 1,800 μm or less, more preferably 1,300 μm or less, still more preferably less than 1,100 μm. When the outside diameter of the hollow-fiber membrane is small, at the time of packing a maximum amount of the membrane into a module, the membrane area becomes large and in turn, the permeation amount of product water increases.

On the other hand, the lower limit of the outside diameter may be set according to the strength required against bending and breaking of the hollow-fiber membrane but is preferably 750 μm or more, more preferably 850 μm or more, still more preferably 950 μm or more.

### 2-2. Inside Diameter

The inside diameter of the hollow-fiber membrane of the present invention may be set according to the outside diameter, and the upper limit thereof is preferably 1,000 μm or less, less than 700 μm, or less than 600 μm, because collapse resistance increases. On the other hand, when the inside diameter is set large, the pressure loss is reduced and therefore, the amount of water passing through the inside, i.e., the permeate amount, increases. For this reason, the lower limit is preferably 180 μm or more, more preferably 320 μm or more, still more preferably 550 μm or more.

### 3. Production Method of Porous Molded Body

The method for producing the porous molded body of the present invention is described below by taking a hollow-fiber membrane composed of a crystalline polymer and an inorganic particle as an example. The production method of the hollow-fiber membrane preferably includes:

1) a step of applying a pressure to a membrane forming solution containing a crystalline polymer and an inorganic particle on a liquid feeding line before a spinneret,

2) a step of discharging the membrane forming solution pressurized in 1) above from the spinneret to form an unoriented hollow-fiber membrane with high thickness uniformity by thermally induced phase separation near the crystallization temperature of the membrane forming solution, and

3) a step of stretching the unoriented hollow-fiber membrane obtained in 2) above in the longitudinal direction of the membrane to obtain a highly oriented columnar texture.

### 3-1. Preparation of Membrane Forming Solution

The production method of a hollow-fiber membrane in this embodiment includes a step of preparing a solution in which a crystalline polymer and an inorganic particle are mixed. A membrane forming solution is prepared by dissolving a crystalline polymer and an inorganic particle in a poor or good solvent for the crystalline polymer at a relatively high temperature of not less than the crystallization temperature.

In addition, before the preparation of the membrane forming solution, a master pellet containing inorganic particles dispersed in a crystalline polymer is prepared in advance and the pellet is dissolved in a good or poor solvent and thus a polymer molded body in which an inorganic particle is incorporated into a columnar texture can be produced. This is considered because when a master pellet is prepared, a crystalline polymer is fused around an inorganic particle and spherical and columnar textures are formed while allowing the inorganic particle and the crystalline polymer in the periphery thereof to serve as a core. The master pellet is preferably prepared by a method of kneading the inorganic particle by a multi-screw kneader, etc. while heating the pellet at not less than the melting point of the crystalline polymer. Kneading by a multi-screw kneader also provides an effect of enabling those having a secondary particle diameter, such as cerium hydrous oxide, to be finely dispersed. FIG. 8 is an enlarged image of a master pellet in which a cerium hydrous oxide having an average particle diameter of 4.5 μm is kneaded into a vinylidene fluoride homopolymer, and it is seen that the cerium hydrous oxide is more finely dispersed than the average of secondary particle diameters at a time when the oxide is in a particulate state.

When the concentration ratio of a crystalline polymer and an inorganic particle to a solvent in the membrane forming solution is high, a columnar texture and an inorganic particle are increased and at the same time, a hollow-fiber membrane having high strength is obtained. On the other hand, when the polymer concentration is high, the porosity of the hollow-fiber membrane becomes large, and the pure-water permeation performance is enhanced. Accordingly, the ratio of the sum of the weight of crystalline polymer and the weight of inorganic particle to the weight of membrane forming solution is preferably from 30 to 60 wt %, more preferably 35 wt % or more and less than 50 wt %, still more preferably 41 wt % or more and less than 48 wt %.

In the present description, the poor solvent is a solvent in which the crystalline polymer cannot be dissolved to a concentration of 5 wt % or more at a low temperature of 60° C. or less but can be dissolved to a concentration of 5 wt % or more in a high-temperature region between 60° C. or more and not more than the melting point of the crystalline polymer. The good solvent is a solvent in which the crystalline polymer can be dissolved to a concentration of 5 wt % or more even in a low-temperature region of 60° C. or less. The non-solvent is defined as a solvent in which the crystalline polymer is neither dissolved nor swollen at a temperature up to the melting point of the crystalline polymer or the boiling point of the solvent.

The poor solvent for the crystalline polymer includes cyclohexanone, isophorone, γ-butyrolactone, methyl isoamyl ketone, propylene carbonate, dimethyl sulfoxide, etc., and a mixed solvent thereof. The good solvent includes N-methyl-2-pyrrolidone, dimethylacetamide, dimethylformamide, methyl ethyl ketone, acetone, tetrahydrofuran, tetramethylurea, trimethyl phosphate, etc., and a mixed solvent thereof. The non-solvent includes water, hexane, pentane, benzene, toluene, methanol, ethanol, carbon tetrachloride, γ-dichlorobenzene, trichloroethylene, ethylene glycol, diethylene glycol, triethylene glycol, propylene glycol, butylene glycol, pentanediol, hexanediol, an aliphatic hydrocarbon such as low-molecular-weight polyethylene glycol, an aromatic hydrocarbon, an aliphatic polyhydric alcohol, an aromatic polyhydric alcohol, a chlorinated hydrocarbon, other chlorinated organic liquids, and a mixed solvent thereof.

### 3-2. Formation of Hollow-Fiber Membrane

In the hollow fiber membrane forming step, a thermally induced phase separation method, in which phase separation is induced by temperature change, is utilized to obtain a (substantially) unoriented hollow-fiber membrane from a membrane forming solution containing a crystalline polymer and an inorganic particle. At this time, when the membrane forming solution before phase separation is retained and pressurized, a fibril grows during the subsequent solidification by cooling, and the columnar texture of the present invention having an aspect ratio of 2 or more is obtained. In this instance, it has been found that the addition of an inorganic particle enables to obtain a columnar texture with high thickness uniformity compared to a case of including only a crystalline polymer (fibrous texture in JP-A-2006-297383). This is considered because due to addition of a particle, the crystalline polymer in the periphery of the particle first produces a crystal nucleus and then the crystalline polymer is incorporated into a fibril in the periphery of the crystal nucleus to promote the growth of the fibril. This columnar structure with high thickness uniformity enables providing high orientation in the subsequent stretching step. Accordingly, more preferred method include obtaining the columnar structure with high thickness uniformity and performing stretching basically at a ratio of 2.0 times or more to form a columnar texture being highly oriented in the long-side direction (stretching direction). A membrane with higher strength can be obtained by this method, and the method is described in detail below.

As for the phase separation method, a non-solvent induced phase separation method using a non-solvent for the polymer, and a thermally induced phase separation using temperature change are known. Furthermore, as for the thermally induced phase separation method, a solid-liquid separation method in which crystallization of a polymer occurs, a liquid-solid phase separation method in which crystallization of a solvent occurs, and a liquid-liquid phase separation method in which phases are separated in a liquid-liquid state, are known.

Among these, in the solid-liquid phase separation method, it has been found that phase separation occurs due to production and growth of a crystal nucleus and therefore, not only a spherical texture including a polymer crystal is formed but also the inorganic particle transfers to the surface. Accordingly, when a solid-liquid phase separation method is employed, a porous molded body in which an inorganic particle is held between spherical or columnar textures is obtained, and a polymer concentration and a solvent, inducing the solid-liquid phase separation, are selected. In addition, when a solid-liquid phase separation using a raw material prepared by forming a crystalline polymer and an inorganic polymer into a master pellet is employed, a porous molded body in which an inorganic particle is included inside a texture of the crystalline polymer is obtained. Furthermore, the texture in this porous molded body include fine pores, so that the effect of the inorganic particle included inside (for example, adsorption function) can be utilized.

In phase separation other than the solid-liquid separation, the above-described columnar texture oriented in the length direction of the hollow fiber membrane can be hardly developed. In addition to solid-liquid phase separation, a columnar structure with uniform thickness is obtained using the later-described technique, and this is further stretched at a ratio of 2.0 times or more, whereby a highly oriented columnar texture can be formed.

As a specific method, a hollow part-forming liquid is discharged through an inner tube of a double tube-type spinneret while discharging the above-described membrane forming solution from an outer tube of the double tube-type spinneret, and a polymer in the membrane forming solution discharged in this way is cooled and solidified in a cooling bath to obtain an unoriented hollow-fiber membrane.

At this time, the membrane forming solution is, before being discharged through the spinneret, held at a specific temperature condition for a given time under pressure. The pressure is preferably 0.5 MPa or more, more preferably 1.0 MPa or more. The temperature T of the membrane forming solution preferably satisfies Tc+35° C.≤T≤Tc+60° C., more preferably Tc+40° ° C.≤T≤Tc+55° C. Tc is a crystallization temperature of the membrane forming solution. The time for which the membrane forming solution is held under these pressure and temperature is preferably 10 seconds or more, more preferably 20 second or more.

Specifically, a retention part for allowing the membrane forming solution to stay is provided at any site of a liquid supplying line of supplying the membrane forming solution to the spinneret, and a pressurizing unit for applying a pressure to the retained membrane forming solution and a temperature-adjusting unit for adjusting the temperature of the retained membrane forming solution (for example, a heating unit) are provided. The pressurizing unit is not particularly limited, but by disposing two or more pumps in the solution supplying line, a pressure can be applied to any site therebetween. The pump includes a piston pump, a plunger pump, a diaphragm pump, a wing pump, a gear pump, a rotary pump, a screw pump, etc., and two or more kinds of the pumps may be used.

Through this step, a pressure is applied under the conditions, in which crystallization easily takes place, crystal growth in the subsequent cooling step has anisotropy and in turn, not an isotropic spherical structure but a texture oriented in the length direction of the porous hollow-fiber membrane is developed, as a result, a porous molded body including a columnar texture having an aspect ratio of 2 or more of the present invention can be obtained.

Here, the crystallization temperature Tc of the membrane forming solution is defined as follows. Using an apparatus for differential scanning calorimetry (DSC measurement), a mixture having the same composition as the membrane forming solution composition containing a crystalline polymer, a solvent, etc. is sealed in a sealing type DSC container and the mixture is uniformly dissolved by raising the temperature to a dissolution temperature at a temperature rise rate of 10° C./min and the temperature thereof is held for 30 minutes, and the temperature is lowered at a temperature drop rate of 10° C./min while a rise temperature of a crystallization peak observed in the process is Tc.

The step of cooling the membrane forming solution discharged from a spinneret is described below. As described above, when the membrane forming solution is retained and pressurized before being discharged from the spinneret, a crystal having anisotropy is grown in the cooling step, and a columnar texture having an aspect ratio of 2 or more is obtained. At this time, it has been found that due to addition of a particle, a crystalline polymer in the periphery of the particle preferentially produces a crystal nucleus and subsequent incorporation of the crystalline polymer into a fibril is promoted, as a result, the thickness uniformity of the columnar texture increases. It has also been found that as the method for further increasing the uniformity of the columnar texture, when solidification by cooling in this step is caused to gradually proceed, a polymer is readily incorporated also into a narrowed portion present between crystals in the fibril and a columnar structure with higher thickness uniformity is obtained. Growth by incorporation of a polymer into a narrowed portion leads to disappearance of a narrowed portion having high interface energy and the columnar texture is thought to be energetically stabilized, and the polymer uptake/growth can be caused to preferentially occur over the growth in portions other than the narrowed portion, and the thickness uniformity can thereby be enhanced.

In the cooling bath here, a mixed liquid including a poor or good solvent in a concentration of 50 to 95 wt % and a non-solvent in a concentration of 5 to 50 wt % is preferably used. For the poor or good solvent, the same solvent as that in the membrane forming solution is preferably used. For the non-solvent, water is inexpensive and is preferably employed. In this step, thermally induced phase separation and non-solvent induced phase separation occur competitively, but by setting the concentration within the ranges above, thermally induced phase separation can be generated. As the hollow part-forming liquid, similarly to the cooling bath, a mixed liquid including a poor or good solvent in a concentration of 50 to 95 wt % and a non-solvent in a concentration of 5 to 50 wt % is preferably used. For the poor or good solvent, the same poor or good solvent as that in the membrane forming solution is preferably employed.

In order to obtain a columnar structure with high thickness uniformity, when the crystallization temperature of the membrane forming solution is denoted by Tc and the temperature of the cooling bath is denoted by Tb, Tc−30° C.<Tb≤Tc is preferably satisfied, and it is more preferable to satisfy Tc−20° C.<Tb≤Tc. It has been found that within the temperature range above, solidification by cooling in the cooling bath can proceed near the crystallization temperature of the membrane forming solution, leading to gradual progress of solidification by cooling, and incorporation of a polymer into a narrowed portion is thereby facilitated to enable uniformization of the thickness. In this case, growth by incorporation of a polymer into a narrowed portion can be promoted here so as to form not a fibrous texture having a large number of narrowed portions but a columnar texture having uniform thickness.

As for the passing time through the cooling bath (i.e., dipping time in the cooling bath), it is important to ensure enough time to complete the thermally induced phase separation including growth by incorporation of a polymer into a narrowed portion, and the passing time may be determined by taking into account the number of hollow-fiber membranes, the spinning speed, the bath ratio, the cooling capacity, etc. In order to achieve thickness uniformity, the passing time is preferably set as long as possible within the above-described temperature range of the cooling bath and may be, for example, 10 seconds or more, preferably 20 seconds or more, more preferably 30 seconds or more.

In addition, it is effective to perform two or more stages of cooling. Specifically, the cooling step may include a step of performing the cooling by using a first cooling bath for increasing the supercooling degree and thereby promoting generation/growth of a crystal nucleus, and a step of thereafter performing the cooling by using a second cooling bath for promoting growth by incorporation of a polymer into a narrowed portion. The cooling step by the second cooling bath utilizes a phenomenon that the growth by incorporation of a polymer into a narrowed portion preferentially occurs mainly in the structure coarsening process during phase separation.

In this case, when the temperature Tb1 of the first cooling bath satisfies Tb1≤Tc−30° C., the generation and growth of a crystal nucleus can be promoted by increasing the supercooling degree, and when the temperature Tb2 of the second cooling bath is set near the crystallization temperature (specifically, set to satisfy Tc−30° C.<Tb2≤Tc, more preferably Tc−20° C.<Tb2≤Tc), the growth by incorporation of a polymer into a narrowed portion can be promoted. At this time, since an inorganic particle is rapidly fixed in the first cooling step, inorganic particles can be highly dispersed even when added at a high concentration of 20 wt % or more.

The passing time through each cooling bath can vary but is preferably set, for example, such that the passing time through the first cooling bath is from 1 to 20 seconds, preferably from 3 to 15 seconds, more preferably from 5 to 10 seconds, and the passing time through the second cooling bath is 10 seconds or more, preferably 20 seconds or more, more preferably 30 seconds or more.

### 3-3. Stretching

Finally, in the present invention, the unoriented porous hollow-fiber membrane including a crystalline polymer, obtained by the method above, is preferably stretched at a high ratio in the longitudinal direction to form a highly oriented columnar texture while orienting the columnar texture in the long-side direction. Based on the finding that an unoriented hollow-fiber membrane having a columnar texture with high thickness uniformity can be obtained by adding an inorganic particle and the columnar texture as a whole can thereby be uniformly stretched, stretching at a high ratio of 2.0 times or more becomes possible. A highly oriented columnar texture is obtained by such uniform and high-ratio stretching, and a porous molded body with higher strength is thereby successfully realized. In addition, it is found that when an inorganic particle is included inside, the effect of stretching increases. These are described below.

First, a case where an inorganic particle is positioned outside of a columnar texture is described. In this case, it is found that when the columnar texture before stretching is drawn out, the void becomes coarser and an optimal space to fix an inorganic particle is produced. In addition, when the columnar texture is drawn out and highly oriented, the columnar texture is drawn out while averaging the columnar texture thickness and an inorganic particle is positioned to lie between a columnar texture and a columnar texture. Since the inorganic particle is fixed to the columnar texture, for example, boron-containing water is readily put into contact with the inorganic particle and, for example, when the inorganic particle is an inorganic particle having an adsorption function, the adsorption rate increases. The stretch ratio is preferably from 2.0 to 5.0 times, more preferably from 2.2 to 4.0 times, still more preferably from 2.5 to 3.5 times. By setting the stretch ratio as high as 2.0 times, the columnar texture can be highly oriented to provide high strength. On the other hand, by setting the stretch ratio to be 5.0 times or less, stable production is realized. The stretching temperature is preferably from 60 to 140° C., more preferably from 70 to 120° C., still more preferably from 80 to 100° C. When the stretching temperature is 60° C. or more, the membrane can be stably stretched in view of production, and when the membrane is stretched at 140° C. or less, the columnar texture is readily oriented. Stretching is preferably performed in a liquid because of ease of temperature control but may be performed in a gas such as steam. As the liquid, water is inexpensive and is preferred, but in the case of stretching the membrane at about 90° C. or more, use of a low-molecular-weight polyethylene glycol, etc. may also be preferably employed.

Next, a case where an inorganic particle is included inside of a columnar texture is described. Also in this case, the columnar texture before stretching is drawn out to make a highly oriented columnar structure, but in the case of including an inorganic particle inside, the columnar texture before stretching is in a condition susceptible to crystal growth, and a highly oriented columnar texture is obtained at a relatively low stretch ratio, compared with the case where an inorganic particle is positioned outside of the texture. The stretch ratio is preferably from 1.5 to 5.0 times, more preferably from 2.0 to 4.0 times, still more preferably from 2.2 to 3.5 times. The reason why a hollow-fiber membrane with high strength can be obtained even by stretching at a relatively low ratio of 1.5 times or more is considered because as well as the modulus-increasing effect of the inorganic particle, due to production of a large number of crystal nuclei around the inorganic particle, growth by incorporation of a polymer is likely to proceed. Other conditions and effects are the same as those in the case of an inorganic particle being positioned outside. In addition, maybe for the reason that stress concentration on the inorganic particle is prevented due to inclusion of an inorganic particle inside a columnar texture, a membrane with higher strength can be obtained, and it is even possible to obtain a membrane having a breaking strength of 10 MPa or more. Furthermore, it has been found that by performing stretching, the fine pore in the columnar texture surface can be enlarged as illustrated in FIGS. 9 to 11. In the case where an inorganic particle having an adsorption function is included inside a columnar texture, the fine pore in the columnar texture surface can be enlarged by performing high-ratio stretching, and this advantageously facilitates water passing to the inorganic particle, thus it is preferable.

### 4. Method of Using Porous Molded Body

The porous molded body of the present invention is used: in the case of a hollow-fiber membrane shape, for a module filter; in the case of a flat membrane, for a cartridge filter; in the case of a fibrous shape, for a bobbin filter or a cartridge filter formed into a knitted fabric or a nonwoven fabric; for a column by breaking the porous molded body into fine pieces; etc. For example, a hollow-fiber membrane module includes a plurality of hollow-fiber membranes and a cylindrical case in which a hole is provided on the side surface and the hollow-fiber membranes above are housed. The plurality of hollow-fiber membranes are bundled and fixed at both ends or at one end to the case with a polyurethane or epoxy resin, etc. In the following, the preferable method for operating the hollow-fiber membrane module of the present invention is described by referring to the drawings. Note that the present invention is not limited to the following embodiment.

First, a hollow-fiber membrane module and a membrane filtration apparatus, to which the method for operating a hollow-fiber membrane module of the present invention is applied, are described. The hollow-fiber membrane module is, for example, a hollow-fiber membrane module 1a as illustrated in FIG. 12, in which a large number of hollow-fiber membranes each having an adsorption function are bonded/fixed to a cylindrical case 2a with an adhesive at an upper bonded part 3a and a lower bonded part 4a, with the membrane being in the state of open, an upper end nozzle 5a and a lower end nozzle 6a each serve as a filtrate outlet or a backwash liquid inlet, an upper lateral nozzle 7a discharges cleaning waste liquid, and a lower lateral nozzle 8a serves as a raw water inlet or discharge cleaning waste liquid.

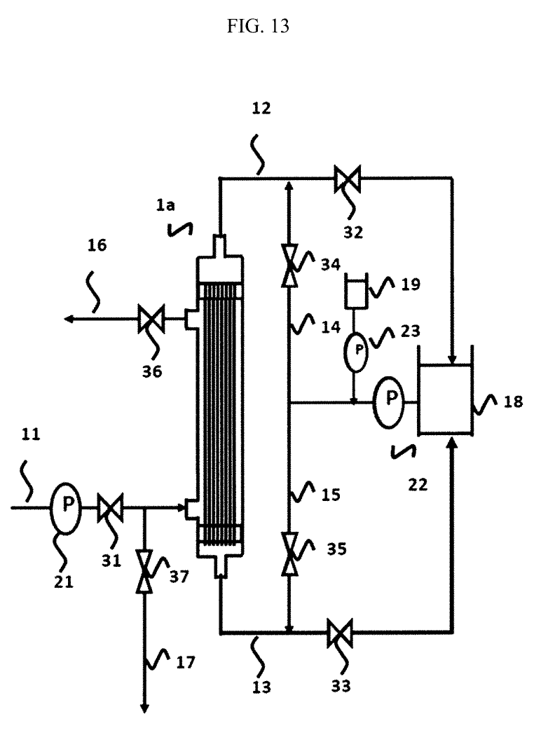

The membrane filtration apparatus has, for example, as illustrated in FIG. 13, a feed-water pipe 11 which supplies water to be treated, and is connected to the lower lateral nozzle 8a of the hollow-fiber membrane module 1a, a filtrate pipe 12 which supplies membrane filtrate to a filtrate tank 18 and is connected to the upper end nozzle 5a, a filtrate pipe 13 which supplies membrane filtrate to the filtrate tank 18 and is connected to the lower end nozzle 6a, a backwash water pipe 14 which supplies backwash water to the upper end nozzle 5a and is connected to the filtrate pipe 12, a backwash water pipe 15 which supplies backwash water to the lower end nozzle 6a and is connected to the filtrate pipe 13, a backwash water pipe 16 which discharges backwash water, and is connected to the upper lateral nozzle 7a, and a drain pipe 17 which discharges backwash water from the lower lateral nozzle 8a and is connected to the feed-water pipe 11.

This membrane filtration apparatus includes a pump 21 which supplies water to be treated through the feed-water pipe 11, a feed-water valve 31 which turns to the open position at the time of water to be treated being supplied, a filtrate valve 32 which turns to the open position at the time of taking out membrane filtrate through the upper end nozzle 5a, and a filtrate valve 33 which turns to the open position at the time of taking out membrane filtrate through the lower end nozzle 6a, and includes a backwash pump 22 which supplies backwash water at the time of cleaning the hollow-fiber membrane module 1, a backwash water valve 34 which turns to the open position at the time backwash water being supplied through the upper end nozzle 5a, a backwash water valve 35 which turns to the open position at the time backwash water being supplied through the lower end nozzle 6a, a cleaning wastewater valve 36 which turns to the open position at the time of discharging backwash water through the upper lateral nozzle 7a, and a cleaning wastewater valve 37 which turns to the open position at the time of discharging backwash water through the lower lateral nozzle 8a. Furthermore, the membrane filtration apparatus includes a chemical liquid tank 19 which stores a chemical liquid for restoring the adsorption function of the hollow-fiber membrane module, and a chemical liquid pump which supplies a chemical liquid to the backwash water pipes 14 and 15.

The method for operating the hollow-fiber membrane module 1a using this membrane filtration apparatus is described below. Usual operation of the hollow-fiber membrane module includes a water supplying step of filling the hollow-fiber membrane module with water to be treated, a filtration step of membrane-filtering water to be treated to obtain membrane filtrate, a backwashing step of cleaning the hollow-fiber membrane that is clogged in the filtration step due to contaminant components in water to be treated, and a draining step of discharging backwash wastewater present within the hollow-fiber membrane module 1a, and one filtration cycle includes sequential performance of these steps. The hollow-fiber membrane module is operated by repeating this filtration cycle.

The water supplying step is a step of supplying water to be treated to the hollow-fiber membrane module 1a through the lower lateral nozzle 8a by use of the supply pump 21 and discharging the overflow portion through the upper lateral nozzle 7a. At this time, the feed-water valve 31 and the cleaning wastewater valve 36 are turned to the open position. The filtration step includes a filtration step 1 of supplying water to be treated to the hollow-fiber membrane module 1a through the lower lateral nozzle 8a by use of the supply pump 21 and taking out membrane filtrate filtered with the hollow-fiber membrane through the upper end nozzle 5a, and a filtration step 2 of taking out the membrane filtrate through the lower end nozzle 6a. In the filtration step 1, the feed-water valve 31 and the filtrate valve 32 are turned to the open position, and in the filtration step 2, the feed-water valve 31 and the filtrate valve 33 are turned to the open position. The backwashing step includes a backwashing step 1 of supplying backwash water through the upper end nozzle 5a by use of the backwash pump 22 from the membrane filtrate tank 18 and discharging the backwash wastewater having passed the hollow-fiber membrane through the upper lateral nozzle 7, and a backwashing step 2 of supplying backwash water through the lower end nozzle 6a by use of the backwash pump 22 and discharging the backwash wastewater having passed the hollow-fiber membrane though the upper lateral nozzle 7. In the backwashing step 1, the backwash water valve 34 and the cleaning wastewater valve 36 are turned to the open position, and in the backwashing step 2, the backwash water valve 35 and the cleaning wastewater valve 36 are turned to the open position. The draining step is a step of discharging the backwash wastewater remaining inside of the hollow-fiber membrane module 1a from the lower lateral nozzle 8a via the drain pipe 17. The cleaning wastewater valve 36 and the wastewater valve 37 are turned to the open position. One filtration cycle includes sequential performance of these steps. The hollow-fiber membrane module is operated by repeating this filtration cycle.

In addition, this method for operating the hollow-fiber membrane module includes a regeneration step of restoring the adsorption function of the hollow-fiber membrane, which is reduced as the operation continues. In the regeneration step, the function is regenerated by injecting a chemical liquid into the backwash water pipe in the backwashing step 1 or 2 by use of the chemical liquid pump 23 from the chemical liquid tank 19 storing a chemical liquid for restoring the adsorption function of the hollow-fiber membrane.

In the method for operating the hollow-fiber membrane module of the present invention, a filtration cycle 1 including at least the filtration step 1 and a filtration cycle 2 including at least the filtration step 2 are preferably performed at least one or more times between regeneration steps, i.e., between performing a regeneration step and performing a next regeneration step. If only one of those cycles is performed between regeneration steps, a distribution is created in the pressure difference between membranes in the longitudinal direction due to a pressure loss inside of the hollow-fiber membrane and since the membrane filtration flux of the hollow fiber has a distribution in the longitudinal direction, the membrane filtration flux is high in a position close to the end face to rapidly reach saturation of the adsorption capacity, whereas the membrane filtration flux is low in a position farther from the taking-out end face to take much time until the adsorption capacity is saturated. Accordingly, as the effective length in the longitudinal direction of the hollow-fiber membrane is longer, breakthrough starts at an earlier stage than the adsorption capacity originally possessed by the hollow-fiber membrane, and the interval between regeneration steps is shortened. However, in the case of performing both cycles, since the end face for taking out the membrane filtrate is switched, at the time of taking out the membrane filtrate from one end face, the adsorption capacity remains without reaching saturation of the adsorption capacity in a position farther from the end face, but when the end face for taking out the membrane filtrate is switched to another end face, while the pressure difference between membranes at a site having the remaining adsorption capacity increases and the remaining adsorption capacity can be used up, the pressure difference between membranes at a site having little remaining adsorption capacity decreases and leakage from the site is also reduced, so that a rise in the concentration of specific components in membrane filtrate can be prevented.

Accordingly, the amounts of membrane filtrates obtained from the filtration cycle 1 and the filtration cycle 2 between the regeneration steps are preferably the same. Specifically, the ratio V1/V2, of which the amount V1 of the membrane filtrate being obtained from the filtration cycle 1 and the amount V2 of the membrane filtrate being obtained from the filtration cycle 2 between regeneration steps, is preferably from 0.7 to 1.3, more preferably from 0.8 to 1.2, still more preferably from 0.9 to 1.1. Within this range, the adsorption capacity of the hollow-fiber membrane can be sufficiently used up.

The method for making the amounts of filtrates the same is preferably a method of switching the filtration cycle 1 and the filtration cycle 2 alternately every time. By this method, the ratio V1/V2 can be made to be from 0.9 to 1.1.

It is also preferable to apply a method in which the filtration cycle 1 is performed multiple times and then switched to the filtration cycle 2.

In addition, it is preferable to combine the backwashing step 2 after the filtration step 1 in the filtration cycle 1 and combine the backwashing step 1 after the filtration step 2 in the filtration cycle 2. Usually, in the backwashing, the cleaning is performed in general by supplying backwash water from the end face on the side where the membrane filtrate is taken out in the filtration step, but even at the time of backwashing, a distribution is created in the pressure difference between membranes in the longitudinal direction of the hollow-fiber membrane and therefore, it is likely that the cleaning flux is high in a position close to the end face receiving a supply of the backwash water and the cleaning flux is small in a position farther from the end face. Consequently, the cleaning effect of the backwashing increases in a position close to the end face, and the filtration flux always remains high. On the other hand, in the case where the end nozzle for taking out membrane filtrate in the filtration step is different from the end nozzle for supplying backwash water in the backwashing step, at a site having a high filtration flux close to the end nozzle in the filtration step, the cleaning flux becomes small in the backwashing step to provide a small cleaning effect and therefore, the filtration flux at the site is reduced. Furthermore, at a site having a small filtration flux farther from the end nozzle in the filtration step, the cleaning flux becomes large in the backwashing step to provide a large cleaning effect and in turn, reduction in the filtration flux at the site can be prevented. As a result, the filtration flux distribution in the longitudinal direction of the hollow-fiber membrane is averaged, and the difference between a high filtration flux site and a low filtration flux site becomes small, so that the adsorption capacity of the hollow-fiber membrane module can be sufficiently used up.

The flux at the time of filtration is not particularly limited, but the fluxes in the filtration step 1 and the filtration step 2 are preferably the same.

When a module having housed therein the hollow-fiber membrane of the present invention is used as a separation membrane for pretreatment in seawater desalination, for example, removal of suspended components and boron compounds contained in seawater can be performed at the same time.

### EXAMPLES

The present invention is described below by referring to specific Examples, but the present invention is not limited to these Examples. Physical property values relating to the present invention can be measured by the following methods.

### (1) Long Side, Short Side and Aspect Ratio of Columnar Texture

A photograph of a cross-section in the longitudinal direction of the porous hollow-fiber membrane was taken at a magnification of 3,000 times by a scanning electron microscope, etc. First, the length at a site having the longest long side of a columnar texture was measured, and the length of the texture was then measured by drawing a line vertically from the central part of the long site. Each length was measured in the same manner for 20 columnar textures and after calculating an average thereof, the average of lengths at the longest sites and the average of lengths at the sites formed by vertically drawing a line were defined as the long side and the short side, respectively. The aspect ratio was determined as (long side/short side).

### (2) Occupancy of Columnar Texture

A photograph of a cross-section in the longitudinal direction of the porous hollow-fiber membrane was taken by means of a scanning electron microscope at a magnification of 3,000 times in arbitrary 20 places. The photograph taken was printed on paper, and the area occupied by the texture was determined by replacing respective areas of entire photograph and texture by the weight of paper corresponding to the entire photograph and the weight of paper corresponding to the texture portion cut out from the photograph. A value obtained by dividing the determined footprint of the columnar texture by the footprint of the entire molded body and multiplying the resulting value by 100 is defined as the occupancy.

### (3) Thickness Uniformity of Columnar Texture

First, the porous hollow-fiber membrane was resin-embedded in an epoxy resin, and a void portion was thereby filled with the epoxy resin. At this time, osmium dyeing treatment was performed. Next, using a scanning electron microscope (SEM) equipped with a focused ion beam (FIB), a face perpendicular to the longitudinal direction of the porous hollow-fiber membrane was cut out by FIB, and FIB cutting work and SEM observation were repeatedly conducted 200 times at 50 nm intervals toward the longitudinal direction of the porous hollow-fiber membrane to obtain information at a depth of 10 μm.

The thickness uniformity was determined by comparing a first cross-section and a second cross-section each running perpendicularly to the longitudinal direction of the porous hollow-fiber membrane, which were obtained in continuous cross-section observation using FIB above. Here, 20 pairs of first cross-section and second cross-section were selected such that these cross-sections work out to faces running in parallel to each other and being spaced 5 μm apart. First, in each cross-section, a portion composed of a crystalline polymer and a void portion (epoxy portion) were distinguished, and the area of the crystalline polymer portion and the area of the void portion were measured. Subsequently, the area of a portion where when the first cross-section is projected onto the second cross-section from a direction perpendicular to both cross-sections, the portion composed of the resin in the first cross-section and the portion composed of the resin in the second cross-section are overlapped, was determined and defined as the overlap area. The thickness uniformity was calculated as a value determined by averaging thickness uniformities A and B obtained according to the following formulae (1) and (2), and an average value of 20 pairs was employed. The membrane was determined to have a columnar texture when 16 pairs or more have a thickness uniformity of 0.60 or more, and determined to have a fibrous texture when 15 pairs or less have the thickness uniformity above.

Thickness uniformity A=(overlap area)/(area of crystalline polymer portion of second cross-section) formula (1)

Thickness uniformity B=(overlap area)/(area of crystalline polymer portion of first cross-section) formula (2)

### (4) Orientation Degree π of Molecular Chain in Long-Side Direction

The porous molded body was fixed to a sample stage by arranging the long-side direction of the columnar texture to run vertically, and the porous hollow-fiber membrane was irradiated with an X-ray beam perpendicularly to the longitudinal direction of the porous hollow-fiber membrane by using an X-ray diffractometer (manufactured by Rigaku Corporation, SmartLab for polymer). Subsequently, the intensity in the range from 0° to 360° in the azimuth angle direction, relative to the diffraction peak around 2θ=20.4°, was measured to obtain an intensity distribution in the azimuth angle direction. Here, it is regarded that a peak was present when the ratio between the intensity at an azimuth angle of 180° and the intensity at an azimuth angle of 90° was 0.83 or less or 1.20 or more, the width at a position of half the peak height (half-width H) was determined in the intensity distribution in this azimuth angle direction, and the orientation degree π was calculated according to the following formula (3):

Orientation degree π=(180°−H)/180° formula (3)

(in which H is a half-width of an intensity distribution obtained by scanning a crystal peak in a circumferential direction in the wide-angle X-ray diffraction determination).

### (5) Porosity

The porosity was determined according to the following formula (4) by using the area of the crystalline polymer portion and the area of the void portion in arbitrary 30 cross-sections obtained in the section (3) above, and an average value thereof was used.

Porosity (%)=(100×(area of void portion))/{(area of crystalline polymer portion)+(area of void portion)} formula (4)

### (6) Crystallization Temperature Tc of Membrane Forming Solution

Using DSC-6200 manufactured by Seiko Instruments & Electronics Ltd., a mixture having the same composition as the membrane forming solution composition containing a crystalline polymer, a solvent, etc. was sealed in a sealing type DSC container and uniformly dissolved by raising the temperature to a dissolution temperature at a temperature rise rate of 10° C./min and holding the temperature for 30 minutes, and a rise temperature of a crystallization peak observed in the process of thereafter lowering the temperature at a temperature drop rate of 10° C./min was defined as the crystallization temperature Tc.

### (7) Breaking Strength, Elongation at Break

Using a tensile tester (TENSILON (registered trademark)/RTM-100, manufactured by Toyo Baldwin Co., Ltd.), a sample having a measurement length of 50 mm was tested 5 or more times at a tensile speed of 50 mm/min by changing the sample, and the breaking strength and elongation at break were calculated by determining average values thereof.

### (8) Pure-Water Permeation Performance

A compact module including 4 porous hollow-fiber membranes and having an effective length of 200 mm was manufactured. Distilled water was delivered to the module over 1 hour under the conditions of a temperature of 25° C. and a filtration pressure difference of 16 kPa, and the amount (m³) of the obtained permeate was measured, converted into a numerical value per unit time (h) and unit membrane area (m²), further converted in terms of a pressure (50 kPa), and used as the pure-water permeation performance (m³/m²/h). The unit membrane area was calculated from the average outside diameter and the effective length of the porous hollow-fiber membrane.

### (9) Boron Removal Rate

Using the compact module manufactured in (8) above, seawater collected in Matsuyama, Ehime, Japan was subjected to external pressure total filtration for 30 minutes under the conditions of a temperature of 25° C. and a filtration differential pressure of 16 kPa, and the concentrations of boron present in the feed water and permeate were measured. For the measurement of boron concentration, an ICP emission spectrometer (P-4010, manufactured by Hitachi, Ltd.) was used. The boron removal performance was evaluated by the boron removal rate defined by the following formula:

(Boron removal rate)={1−(boron concentration in permeate)/(boron concentration in feed water)}×100 formula (5)

### Example 1

27 wt % of a vinylidene fluoride homopolymer having a weight average molecular weight of 417,000 and 60 wt % of γ-butyrolactone were dissolved by stirring at 150° C., and 13 wt % of cerium hydrous oxide having a particle diameter of 4.5 μm was further mixed to obtain a membrane forming solution. By disposing two gear pumps, the membrane forming solution was pressurized to 2.0 MPa on a line between the two gear pumps and retained for 20 seconds at 99 to 101° C., thereafter discharged through the outer tube of a double tube-type spinneret, while an aqueous 85 wt % γ-butyrolactone solution was simultaneously discharged through the inner tube of the double tube-type spinneret. These were allowed to stay in a cooling bath at a temperature of 25° C. containing an aqueous 85 wt % γ-butyrolactone solution for 20 seconds and thereby solidified.

Subsequently, the solidified product was stretched at a ratio of 2.3 times in water at 95° C. to obtain a hollow-fiber membranous porous molded body. The water permeation performance is shown in Table 1 and this was a membrane excellent in the strength and boron removal rate.

The proportion of the inorganic particle in the porous molded body is shown by the ratio of the concentration of the inorganic particle to the sum of the concentration of the crystalline polymer and the concentration of the inorganic particle in the membrane forming solution. For example, in Example 1, the concentration of the inorganic particle in the porous molded body is calculated as 33% from 13/(13+27).

### Example 2

By disposing two gear pumps, the membrane forming solution obtained in Example 1 was pressurized to 2.0 MPa on a line between the two gear pumps and retained for 20 seconds at 99 to 101° C., thereafter discharged through the outer tube of a double tube-type spinneret, while an aqueous 85 wt % γ-butyrolactone solution was simultaneously discharged through the inner tube of the double tube-type spinneret. These were allowed to stay in a first cooling bath at a temperature of 5° C. containing an aqueous 85 wt % γ-butyrolactone solution for 10 seconds and then in a second cooling bath at a temperature of 25° C. containing an aqueous 85 wt % γ-butyrolactone solution for 20 seconds and thereby solidified. Subsequently, the solidified product was stretched at a ratio of 2.6 times in water at 95° C. to obtain a hollow-fiber membranous porous molded body. The water permeation performance is shown in Table 1 and this was a membrane excellent in the strength and boron removal rate.

### Example 3

27 wt % of a vinylidene fluoride homopolymer having a weight average molecular weight of 417,000 and 60 wt % of γ-butyrolactone were dissolved by stirring at 150° C., and 13 wt % of zirconium hydroxide having a particle diameter of 2.3 μm was further mixed to obtain a membrane forming solution. The membrane forming solution was solidified by the same method as in Example 2 except that the temperatures and staying period in the first cooling bath and the second cooling bath were changed as shown in Table 1. Subsequently, the solidified product was stretched at a ratio of 3.1 times in water at 95° C. to obtain a hollow-fiber membranous porous molded body. The water permeation performance is shown in Table 1 and thus, this was a membrane excellent in the strength and boron removal rate.

### Example 4

35 wt % of a vinylidene fluoride homopolymer having a weight average molecular weight of 417,000 and 60 wt % of γ-butyrolactone were dissolved by stirring at 150° C., and 5 wt % of activated carbon was further mixed to obtain a membrane forming solution. The membrane forming solution was solidified by the same method as in Example 2 except that the temperatures and staying period in the first cooling bath and the second cooling bath were changed as shown in Table 1. Subsequently, the solidified product was stretched at a ratio of 2.3 times in water at 95° C. to obtain a porous hollow-fiber membrane of the present invention. The water permeation performance is shown in Table 1, and this was a membrane excellent in the strength. In addition, the DOC removal rate defined by {1−(DOC concentration in permeate)/(DOC concentration in feed water)}×100 was 30% and thus, this was a membrane capable of efficiently removing DOC. Here, DOC means an organic material in a size of 0.45 μm or less.

### Example 5

30 wt % of a vinylidene fluoride homopolymer having a weight average molecular weight of 417,000 and 55 wt % of γ-butyrolactone were dissolved at 150° C., and 15 wt % of cerium hydrous oxide having a particle diameter of 4.5 μm was mixed to obtain a membrane forming solution. The membrane forming solution was solidified by the same method as in Example 2 except that the temperatures and staying period in the first cooling bath and the second cooling bath were changed as shown in Table 1. Subsequently, the solidified product was stretched at a ratio of 2.6 times in water at 95° C. to obtain a porous hollow-fiber membrane of the present invention. The water permeation performance is shown in Table 1 and thus, this was a membrane excellent in the strength and boron removal rate.

### Example 6

27 wt % of a vinylidene fluoride homopolymer having a weight average molecular weight of 417,000 and 60 wt % of dimethylsulfoxide were dissolved at 150° C., and 13 wt % of cerium hydrous oxide having a particle diameter of 4.5 μm was further mixed to obtain a membrane forming solution. By disposing two gear pumps, the membrane forming solution was pressurized to 2.0 MPa on a line between the two gear pumps and retained for 20 seconds at 78 to 80° C., thereafter discharged through the outer tube of a double tube-type spinneret, while an aqueous 90 wt % dimethylsulfoxide solution was simultaneously discharged through the inner tube of the double tube-type spinneret. These were allowed to stay in a cooling bath at a temperature of 25° C. containing an aqueous 85 wt % dimethylsulfoxide solution for 20 seconds and thereby solidified. Subsequently, the solidified product was stretched at a ratio of 2.6 times in water at 95° C. to obtain a porous hollow-fiber membrane of the present invention. The water permeation performance is shown in Table 1 and thus, this was a membrane excellent in the strength and boron removal rate.

### Example 7

30 wt % of a vinylidene fluoride homopolymer having a weight average molecular weight of 417,000 and 55 wt % of dimethylsulfoxide were dissolved at 150° C., and 15 wt % of cerium hydrous oxide having a particle diameter of 4.5 μm was further mixed to obtain a membrane forming solution. By disposing these gear pumps, the membrane forming solution was pressurized to 2.0 MPa on a line between the two gear pumps and retained for 20 seconds at 78 to 80° C., thereafter discharged through the outer tube of a double tube-type spinneret, while an aqueous 90 wt % dimethylsulfoxide solution was simultaneously discharged through the inner tube of the double tube-type spinneret. These were allowed to stay in a first cooling bath at a temperature of −5° C. containing an aqueous 85 wt % dimethylsulfoxide solution for 10 seconds and then in a second cooling bath at a temperature of 20° C. containing an aqueous 85 wt % of dimethylsulfoxide for 50 seconds and thereby solidified. Subsequently, the solidified product was stretched at a ratio of 3.1 times in water at 95° C. to obtain a hollow-fiber membranous porous molded body. The water permeation performance is shown in Table 1 and this was a membrane excellent in the strength and boron removal rate.

### Example 8

A fibrous porous molded body was obtained by performing solidification and stretching by the same method as in Example 1 except that by disposing these gear pumps, the membrane forming solution obtained in Example 1 was pressurized to 2.0 MPa on a line between the two gear pumps and retained for 20 seconds at 99 to 101° C., thereafter discharged through a fiber spinneret having a hole diameter of 1.1 mm. The performance when the obtained fibrous porous molded body was wound around a cylinder having an open water-collecting holes and evaluated for the boron removal rate is shown in Table 1 and this was a fibrous molded body excellent in the strength and boron removal rate.

### Example 9

The fibrous porous molded body obtained in Example 8 was cut to a length of 10 mm by a pelletizer to obtain a pellet-like porous molded body. The obtained porous molded body was formed into a column shape and evaluated for the boron removal rate and the performance is shown in Table 1 and this was a powdery molded body excellent in the strength and boron removal rate.

### Example 10

70 wt % of a vinylidene fluoride homopolymer having a weight average molecular weight of 417,000 and 30 wt % of cerium hydrous oxide having a particle diameter of 4.5 μm and being previously dried at 70° C. were charged into a twin-screw kneader and kneaded at a cylinder temperature of 200° C. to obtain a master pellet.

42 wt % of the master pellet and 58 wt % of γ-butyrolactone were dissolved and mixed by stirring at 150° C. to obtain a membrane forming solution.

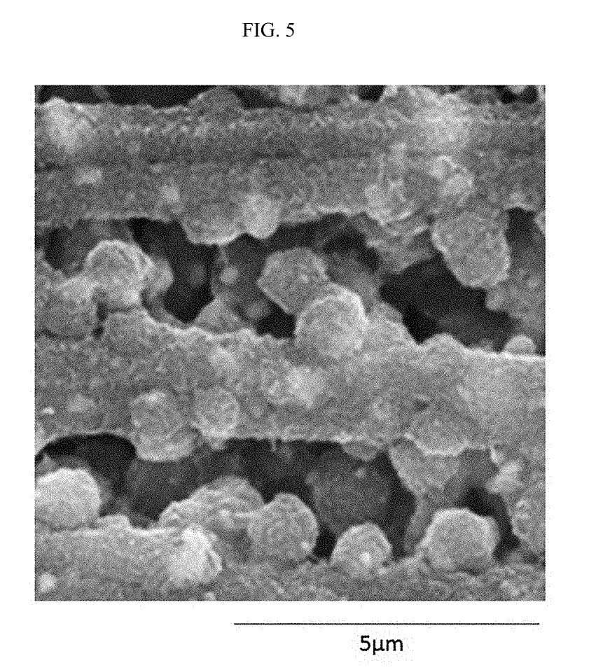

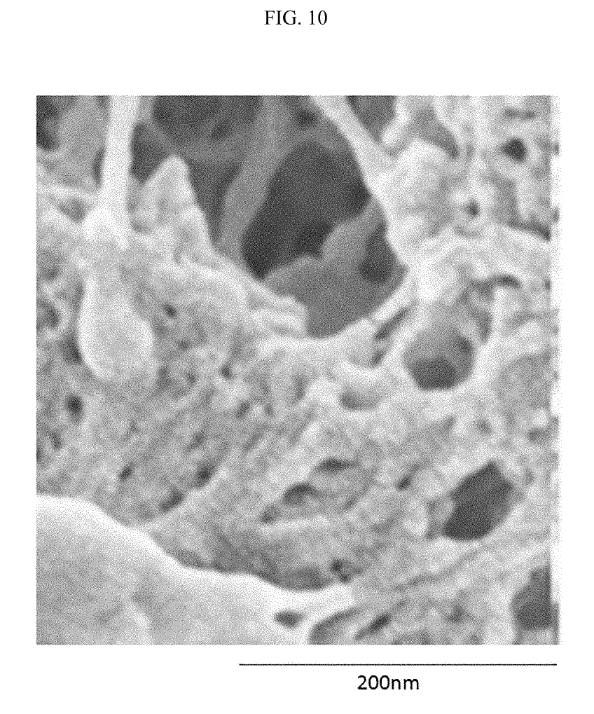

Using this membrane forming solution, a hollow-fiber membranous porous molded body was obtained by the same method as in Example 2. A membrane where an inorganic particle is included inside a columnar texture was obtained. The water permeation performance is shown in Table 1 and thus, this was a membrane excellent in the strength and boron removal rate. FIG. 8 shows an enlarged image of the master pellet, and each of FIG. 5 and FIG. 10 shows an enlarged image of the columnar texture.

### Example 11

A hollow-fiber membranous porous molded body was obtained by the same method as in Example 10 except that the stretch ratio was changed to 1.5 times. A membrane where an inorganic particle is included inside a columnar texture was obtained. The water permeation performance is shown in Table 1 and thus, this was a membrane excellent in the strength and boron removal rate. FIG. 9 shows an enlarged image of the columnar texture.

### Example 12

50 wt % of a vinylidene fluoride homopolymer having a weight average molecular weight of 417,000 and 50 wt % of barium sulfate having a particle diameter of 0.7 μm were charged into a twin-screw kneader and kneaded at a cylinder temperature of 200° C. to obtain a master pellet.

A hollow-fiber membranous porous molded body was obtained by the same method as in Example 11 except that the master pellet above was used. A membrane where an inorganic particle is included inside a columnar texture was obtained. The water permeation performance is shown in Table 1 and thus, the obtained porous molded body was a membrane excellent in the strength and boron removal rate.

### Example 13

70 wt % of a vinylidene fluoride homopolymer having a weight average molecular weight of 417,000 and 30 wt % of barium sulfate having a particle diameter of 1.2 μm were charged into a twin-screw kneader and kneaded at a cylinder temperature of 200° C. to obtain a master pellet.

A hollow-fiber membranous porous molded body was obtained by the same method as in Example 10 except that the master pellet above was used. A membrane where an inorganic particle is included inside a columnar texture was obtained. The water permeation performance is shown in Table 1 and thus, the obtained porous molded body was a membrane excellent in the strength.

### Comparative Example 1

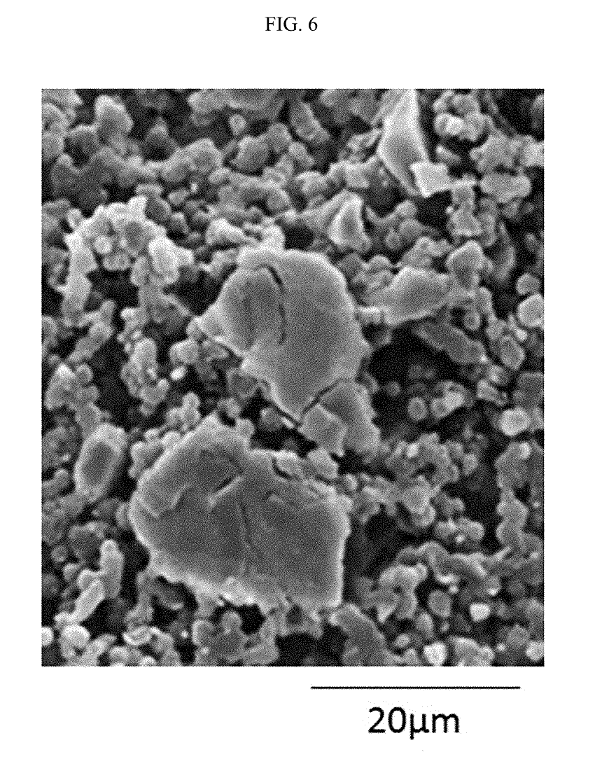

27 wt % of a vinylidene fluoride homopolymer having a weight average molecular weight of 417,000 and 60 wt % of γ-butyrolactone were dissolved by stirring at 150° C., and 13 wt % of cerium hydroxide produced by Wako Pure Chemical Industries, Ltd., which had been pulverized, was further mixed to obtain a membrane forming solution. This membrane forming solution was discharged through the outer tube of a double tube-type spinneret without being pressurized on a line, while an aqueous 85 wt % γ-butyrolactone solution was simultaneously discharged through the inner tube of the double tube-type spinneret. These were allowed to stay in a cooling bath at a temperature of 5° C. containing an aqueous 85 wt % γ-butyrolactone solution for 20 seconds and thereby solidified. Subsequently, the solidified product was stretched at a ratio of 1.5 times in water at 95° C. to obtain a hollow-fiber membranous porous molded body. The structure and performance of the obtained porous hollow-fiber membrane are shown in Table 1 and thus, this was a membrane having poor strength due to a structure in which an inorganic particle is fixed by a spherical texture. FIG. 6 shows an enlarged image of the spherical texture.

### Comparative Example 2

15 wt % of a vinylidene fluoride homopolymer having a weight average molecular weight of 417,000 and 72 wt % of dimethylformamide were dissolved by stirring at 55° C., and 13 wt % of cerium hydrous oxide having a particle diameter of 4.5 μm was further mixed to obtain a membrane forming solution. The membrane forming solution thus obtained was discharged through the outer tube of a double tube-type spinneret without being pressurized on a line, while an aqueous 85 wt % dimethylformamide solution was simultaneously discharged through the inner tube of the double tube-type spinneret. These were allowed to stay in a water bath at a temperature of 40° C. for 20 seconds and thereby solidified to obtain a hollow-fiber membranous porous molded body. The structure and performance of the obtained porous hollow-fiber membrane are shown in Table 1 and thus, this was a membrane having poor strength due to a structure in which an inorganic particle is fixed by a three-dimensional network structure.

### Comparative Example 3

In Comparative Example 1, the stretch ratio was changed to 2.6 times, and stretching was attempted, but breaking occurred frequently, and stable stretching could not be performed.

### Comparative Example 4

It was attempted to stretch the porous hollow-fiber membrane obtained in Comparative Example 2 at a ratio of 2.6 times in water at 95° C., however, breaking occurred frequently, and stable stretching could not be performed.

### Comparative Example 5

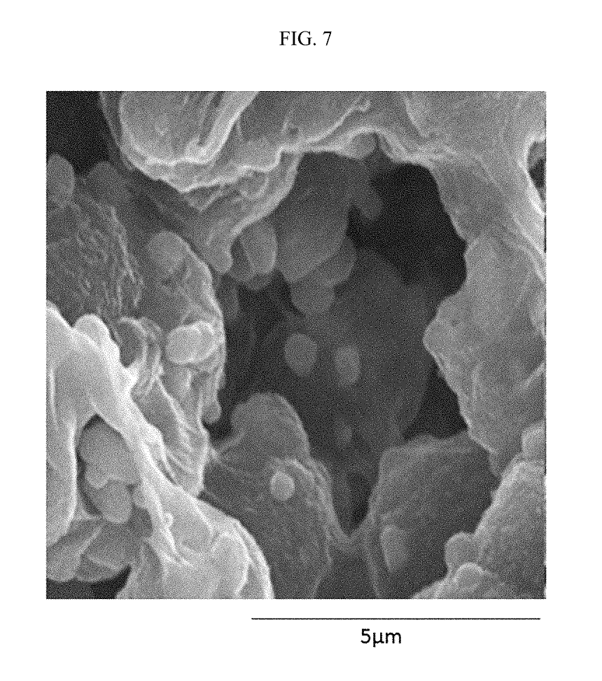

27 wt % of a vinylidene fluoride homopolymer having a weight average molecular weight of 417,000 and 60 wt % of γ-butyrolactone having a particle diameter of 1.2 μm were dissolved by stirring at 150° C., and 13 wt % of barium sulfate was further mixed to obtain a membrane forming solution. This membrane forming solution was discharged through the outer tube of a double tube-type spinneret without being pressurized on a line, while an aqueous 85 wt % γ-butyrolactone solution was simultaneously discharged through the inner tube of the double tube-type spinneret. These were allowed to stay in a cooling bath at a temperature of 5° C. containing an aqueous 85 wt % γ-butyrolactone solution for 20 seconds and thereby solidified. Subsequently, the solidified product was stretched at a ratio of 1.5 times in water at 95° C. to obtain a hollow-fiber membranous porous molded body. The structure and performance of the obtained porous hollow-fiber membrane are shown in Table 1 and thus, this was a membrane having poor strength due to a structure in which an inorganic particle is fixed by a spherical texture. FIG. 7 shows an enlarged image of the spherical texture.

### Comparative Example 6

It was attempted to stretch the porous hollow-fiber membrane obtained in Comparative Example 5 at a ratio of 2.6 times in water at 95° C., however, breaking occurred frequently, and stable stretching could not be performed.

TABLE 1

| | | Example | | | | | | | |
|---|---|---|---|---|---|---|---|---|---|
| | | 1 | 2 | 3 | 4 | 5 | 6 | 7 | 8 |
| Membrane forming | Kind of inorganic particle | Ce | Ce | Zr | activated | Ce | Ce | Ce | Ce |
| solution | | | | | carbon | | | | |
| | Content of inorganic particle (wt %) | 13 | 13 | 13 | 5 | 15 | 13 | 15 | 13 |
| | Content of crystalline polymer (wt %) | 27 | 27 | 27 | 35 | 30 | 27 | 30 | 27 |
| | Kind of solvent | γ-BL | γ-BL | γ-BL | γ-BL | γ-BL | DMSO | DMSO | γ-BL |
| Membrane-forming | Temperature of first cooling bath (° C.) | 25 | 5 | 5 | 5 | 5 | 25 | −5 | 25 |
| conditions | Staying period in first cooling bath (sec) | 20 | 10 | 10 | 10 | 10 | 20 | 10 | 20 |
| | Temperature of second cooling bath (° C.) | — | 25 | 35 | 35 | 35 | — | 20 | — |
| | Staying period in second cooling bath | — | 20 | 50 | 50 | 50 | — | 50 | — |
| | (sec) | | | | | | | | |
| | Stretch ratio (times) | 2.3 | 2.6 | 3.1 | 2.3 | 2.6 | 2.6 | 3.1 | 2.3 |
| Physical property values | Aspect ratio | 3.8 | 6.2 | 7.6 | 5.1 | 6.8 | 7.3 | 8.8 | 4.3 |
| | Thickness uniformity (—) | 0.46 | 0.53 | 0.61 | 0.48 | 0.51 | 0.48 | 0.66 | 0.48 |
| | Occupancy of columnar texture (%) | 58 | 68 | 82 | 62 | 86 | 88 | 93 | 59 |
| | Orientation degree π | 0.52 | 0.61 | 0.66 | 0.56 | 0.64 | 0.57 | 0.69 | 0.52 |
| | Breaking strength (MPa) | 5.9 | 6.6 | 6.9 | 6.1 | 7.3 | 6.4 | 7.6 | 5.7 |
| | Elongation at break (%) | 38 | 47 | 45 | 48 | 47 | 47 | 44 | 56 |
| Water permeation | Pure-water permeation performance | 1.9 | 2.3 | 2.4 | 2.6 | 2.1 | 2.6 | 2.8 | — |
| performance | (m³/m²/hr) | | | | | | | | |
| | Boron removal rate (%) | 23 | 26 | 23 | — | 27 | 27 | 22 | 21 |
| | | Example | | | | | Comparative Example | | |
| | | 9 | 10 | 11 | 12 | 13 | 1 | 2 | 5 |
| Membrane forming | Kind of inorganic particle | Ce | Ce | Ce | Ce | Ba | Ce | Ce | Ba |
| solution | Content of inorganic particle (wt %) | 13 | 12.6 | 12.6 | 21 | 12.6 | 13 | 13 | 13 |
| | Content of crystalline polymer (wt %) | 27 | 29.4 | 29.4 | 21 | 29.4 | 27 | 15 | 27 |
| | Kind of solvent | γ-BL | γ-BL | γ-BL | γ-BL | γ-BL | γ-BL | DMF | γ-BL |
| Membrane-forming | Temperature of first cooling bath (° C.) | 25 | 5 | 5 | 5 | 5 | 5 | 40 | 5 |
| conditions | Staying period in first cooling bath (sec) | 20 | 10 | 10 | 10 | 10 | 20 | 20 | 20 |
| | Temperature of second cooling bath (° C.) | — | 25 | 25 | 25 | 25 | — | — | — |
| | Staying period in second cooling bath | — | 20 | 20 | 20 | 20 | — | — | — |
| | (sec) | | | | | | | | |
| | Stretch ratio (times) | 2.3 | 2.6 | 1.5 | 2.6 | 2.6 | 1.5 | — | 1.5 |
| Physical property values | Aspect ratio | 4.3 | 15.5 | 10.5 | 5.2 | 10.5 | 1.2 | — | 1.2 |
| | Thickness uniformity (—) | 0.48 | 0.72 | 0.63 | 0.65 | 0.63 | — | — | — |
| | Occupancy of columnar texture (%) | 59 | 84 | 79 | 56 | 79 | 4 | 0 | 5 |
| | Orientation degree π | 0.52 | 0.75 | 0.75 | 0.53 | 0.75 | — | — | — |
| | Breaking strength (MPa) | — | 11.2 | 10.3 | 9.4 | 8.3 | 2.7 | 1.8 | 3.3 |
| | Elongation at break (%) | — | 86 | 93 | 35 | 106 | 22 | 25 | 27 |
| Water permeation | Pure-water permeation performance | — | 2.3 | 2.1 | 1.5 | 2.9 | 2.3 | 0.4 | 2.3 |
| performance | (m³/m²/hr) | | | | | | | | |
| | Boron removal rate (%) | 17 | 15 | 13 | 18 | — | 11 | 24 | — |

In Table 1, Ce means cerium hydrous oxide, Zr means zirconium hydroxide, Ba means barium sulfate, γ-BL means gamma-butyrolactone, DMSO means dimethylsulfoxide, and DMF means dimethylformamide.

While the invention has been described in detail and with reference to specific embodiments thereof, it will be apparent to one skilled in the art that various changes and modifications can be made therein without departing from the spirit and scope of the invention. This application is based on Japanese Patent Application (Patent Application No. 2015-190903) filed on Sep. 29, 2015 and Japanese Patent Application (Patent Application No. 2016-050618) filed on Mar. 15, 2016, the contents of which are incorporated herein by way of reference.

### INDUSTRIAL APPLICABILITY

In the porous molded body of the present invention, an inorganic particle is held by a columnar texture, and the strength is high, so that the porous molded body can be used for adsorption of low molecular organic compounds or ions without deformation or breaking even under severe conditions such as in pressurized running water. In addition, when the porous molded body is formed in a hollow-fiber membrane shape, removal and adsorption can be performed at the same time.

### DESCRIPTION OF REFERENCE NUMERALS AND SIGNS

1: Three-dimensional network structure
2: Spherical portion
3: Fibril
4: Inorganic particle
5: Spherical structure
6: Narrowed part
7: Columnar structure
8: Columnar texture

1. A porous molded body comprising:
a plurality of columnar textures each containing a crystalline polymer and having an aspect ratio (long side/short side) of 2 or more, and
an inorganic particle.

2. The porous molded body according to claim 1, wherein long sides of the columnar textures are aligned in a direction from an arbitrary one end to another end.

3. The porous molded body according to claim 1, wherein in the columnar texture, a molecular chain of the crystalline polymer is oriented in the longitudinal direction of the columnar texture and an orientation degree π of the molecular chain calculated, based on the following formula (3), from a half-width H (°) obtained by wide-angle X-ray diffraction measurement is 0.4 or more and less than 1.0:
Orientation degree π=(180°−H)/180° formula (3)
(wherein H is a half-width of an intensity distribution obtained by scanning a crystal peak in a circumferential direction in the wide-angle X-ray diffraction determination).

4. The porous molded body according to claim 1, wherein a thickness uniformity of the columnar texture is 0.45 or more.

5. The porous molded body according to claim 1, wherein a short-side length of the columnar texture is from 0.5 to 3 μm.

6. The porous molded body according to claim 1, wherein the inorganic particle is included inside of the columnar texture.

7. The porous molded body according to claim 1, wherein the crystalline polymer is a fluorine-based resin.

8. The porous molded body according to claim 1, wherein the inorganic particle is any of an oxide, a hydroxide and a hydrous oxide of cerium or zirconium.

9. The porous molded body according to claim 1, which is in a hollow-fiber membrane shape.

10. A method for producing a porous molded body, comprising:
1) a step of dissolving a crystalline polymer and an inorganic particle in a poor solvent for the crystalline polymer to obtain a membrane forming solution,
2) a step of solidifying the membrane forming solution by solid-liquid thermally induced phase separation in a cooling bath, and
3) a step of stretching the solidified product at a ratio of 2.0 to 5.0 times by raising a temperature thereof to 60 to 140° C.

11. A method for producing a porous molded body, comprising:
1) a step of mixing a crystalline polymer and an inorganic particle by melt-kneading,
2) a step of dissolving the mixture in a poor solvent for the crystalline polymer to obtain a membrane forming solution,
3) a step of solidifying the membrane forming solution by solid-liquid thermally induced phase separation in a cooling bath, and
4) a step of stretching the solidified product at a ratio of 1.5 to 5.0 times by raising a temperature thereof to 60 to 140° C.

12. The method for producing a porous molded body according to claim 10, comprising a step of discharging the membrane forming solution in a pressurized state from a spinneret into the cooling bath.

13. A method for operating a hollow-fiber membrane module,
wherein a hollow-fiber membrane bundle formed of a plurality of hollow-fiber membranes is inserted into a cylindrical case having one or more lateral nozzles at least on a side surface and an end nozzle on both end faces, and at both end parts of the hollow-fiber membrane bundle, end face of the hollow-fiber membrane is fixed to the cylindrical case with an adhesive with the end face being open, to form an end bonded part, and
the hollow-fiber membrane has an adsorption function of adsorbing a specific component in water to be treated,
the method comprises a filtration cycle 1 including a filtration step 1 in which water to be treated is treated at least by the hollow-fiber membrane and resulting membrane filtrate is taken out through one end nozzle, a filtration cycle 2 including a filtration step 2 in which at least membrane filtrate is taken out through another end nozzle, and a regeneration step of restoring the adsorption function, and
the filtration cycle 1 and the filtration cycle 2 are performed at least one or more times between the regeneration steps.

14. The method for operating a hollow-fiber membrane module according to claim 13, wherein the amount of membrane filtrate obtained from the filtration cycle 1 and the amount of membrane filtrate obtained from the filtration cycle 2 between the regeneration steps are the same.

15. The method for operating a hollow-fiber membrane module according to claim 13, wherein the filtration cycle 1 and the filtration cycle 2 are switched alternately every time.

16. The method for operating a hollow-fiber membrane module according to claim 13, wherein the filtration cycle 1 includes a backwashing step 1 of supplying the membrane filtrate to the hollow-fiber membrane through a lower end nozzle in the filtration step 1 to perform backwashing after the filtration step 1 and the filtration cycle 2 includes a backwashing step 2 of supplying the membrane filtrate to the hollow-fiber membrane through a lower end nozzle to perform backwashing after the filtration step 2.
